(19) United States
(12) Patent Application Publication
(10) Pub. No.: US 2026/0252341 A1
(43) Pub. Date: Aug. 27, 2026

(54) RESOLUTION OF RECONCILIATION REQUESTS ASSOCIATED WITH A CUSTOM RESOURCE

(71) Applicant: International Business Machines Corporation, Armonk, NY (US)

(72) Inventors: ZHI LI GUAN, HaiDian District (CN); Guo Liang Huang, BEIJING (CN); JIE KE FANG, BEIJING (CN); Shi Su, BEIJING (CN); Hai Wei Fang, Tianjin (CN); Yun Diao, BEIJING (CN); Cheng Wu, BEIJING (CN)

(21) Appl. No.: 19/060,697

(22) Filed: Feb. 23, 2025

(51) Int. Cl. G06F 8/70; G06F 9/48; G06F 9/54

(52) U.S. Cl. CPC G06F 8/70; G06F 9/4881; G06F 9/547

(57) ABSTRACT

Resolution of reconciliation requests associated with a custom resource is provided and includes retrieving one or more reconciliation requests associated with a custom resource from a data structure. The data structure includes a set of reconciliation requests associated with one or more custom resources. The one or more custom resources include the custom resource. The set of reconciliation requests includes the one or more reconciliation requests. Further, one or more rules are retrieved from a set of rules for resolving the one or more reconciliation requests and applied to the one or more reconciliation requests. Based on the application of the one or more rules to the one or more reconciliation requests, the one or more reconciliation requests are resolved and outputted.

### BACKGROUND

The disclosure relates to containerization and more particularly, to custom resources in container platforms.

Operators are a pivotal advancement in Kubernetes® technology, serving as software extensions that leverage custom resources to automate the management of applications and their components within a Kubernetes® cluster. By utilizing these custom resources, the Operators provide a user-friendly interface that aligns with Kubernetes® resource-based interaction model, providing seamless application management.

Operator pattern enables developers to extend the functionality of Kubernetes® without altering its core codebase, thereby promoting modularity and maintainability. This is achieved by associating controllers with one or more custom resources, which allows for the encapsulation of complex application lifecycle management tasks, such as deployment, scaling, and updates, ultimately enhancing the operational efficiency and resilience of cloud-native applications. As a result, the Operators empower organizations to adopt declarative management practices, streamline DevOps workflows, and improve the overall reliability of their Kubernetes® environments.

Reconciliation is a fundamental component of the Kubernetes® reconciliation loop, designed to ensure that the actual state of a cluster aligns with the desired state, a task that the Operators are specifically designed to perform.

### SUMMARY

In various embodiments of the disclosure, a computer-implemented method for resolution of reconciliation requests associated with a custom resource is described. The computer-implemented method includes retrieving, by a computer, one or more reconciliation requests associated with a custom resource from a data structure. The data structure includes a set of reconciliation requests associated with one or more custom resources. The one or more custom resources include the custom resource. The set of reconciliation requests includes the one or more reconciliation requests. The computer-implemented method further includes retrieving, by the computer, one or more rules from a set of rules for resolving the one or more reconciliation requests. The computer-implemented method further includes applying, by the computer, the one or more rules to the one or more reconciliation requests. The computer-implemented method further includes resolving, by the computer, the one or more reconciliation requests based on the application of the one or more rules. The computer-implemented method further includes outputting, by the computer, the resolved one or more reconciliation requests.

In various embodiments of the disclosure, a computer system for resolution of reconciliation requests associated with a custom resource is described. The computer system includes a processor set, one or more computer-readable storage media, and program instructions stored on the one or more computer-readable storage media. The program instructions are executable by the processor set and cause the processor set to intercept a reconciliation request associated with the custom resource. The reconciliation request is transmitted from a container operator associated with a container application hosted on a container platform. The program instructions further cause the processor set to arrange the reconciliation request into a data structure based on an identifier associated with the custom resource. The data structure includes a set of reconciliation requests associated with one or more custom resources. The one or more custom resources include the custom resource. The program instructions further cause the processor set to retrieve one or more reconciliation requests associated with the custom resource from the data structure. The one or more reconciliation requests include the reconciliation request. The set of reconciliation requests includes the one or more reconciliation requests. The program instructions further cause the processor set to retrieve one or more rules from a set of rules for resolving the one or more reconciliation requests. The program instructions further cause the processor set to apply the one or more rules to the one or more reconciliation requests. The program instructions further cause the processor set to resolve the one or more reconciliation requests based on the application of the one or more rules. The program instructions further cause the processor set to output the resolved one or more reconciliation requests.

In various embodiments of the disclosure, a computer-program product for resolution of reconciliation requests associated with a custom resource is described.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures, wherein:

FIG. 1 is a diagram that illustrates a computing environment for resolution of reconciliation requests associated with a custom resource, in accordance with an embodiment of the disclosure;

FIG. 2 is a diagram that illustrates an environment for resolution of reconciliation requests associated with a custom resource, in accordance with an embodiment of the disclosure;

FIG. 3 is a diagram that illustrates exemplary operations for initiation of reconciliation of a custom resource for resolution of reconciliation requests, in accordance with an embodiment of the disclosure;

FIG. 4A is a diagram that illustrates first exemplary operations for resolution of reconciliation requests associated with a custom resource, in accordance with an embodiment of the disclosure;

FIG. 4B is a diagram that illustrates second exemplary operations for resolution of reconciliation requests associated with a custom resource, in accordance with an embodiment of the disclosure;

FIG. 4C is a diagram that illustrates exemplary operations for controlling of reconciliation of a custom resource based on resolution of reconciliation requests, in accordance with an embodiment of the disclosure;

FIG. 5 is a diagram that illustrates exemplary operations for generation of a data structure for resolution of reconciliation requests associated with a custom resource, in accordance with an embodiment of the disclosure;

FIG. 6A is a diagram that illustrates exemplary operations for retrieval of one or more rules for resolution of reconciliation requests associated with a custom resource, in accordance with an embodiment of the disclosure;

FIG. 6B is a diagram that illustrates exemplary operations for modification of a reconciliation request associated with a custom resource, in accordance with an embodiment of the disclosure;

FIG. 7A is a diagram that illustrates an exemplary first user interface for resolution of reconciliation requests associated with a custom resource, in accordance with an embodiment of the disclosure;

FIG. 7B is a diagram that illustrates an exemplary second user interface for resolution of reconciliation requests associated with a custom resource, in accordance with an embodiment of the disclosure;

FIG. 8 is a diagram that illustrates a flowchart of a first exemplary method for resolution of reconciliation requests associated with a custom resource, in accordance with an embodiment of the disclosure; and

FIG. 9 is a diagram that illustrates a flowchart of a second exemplary method for resolution of reconciliation requests associated with a custom resource, in accordance with an embodiment of the disclosure.

### DETAILED DESCRIPTION

The field of cloud-native application management has gained significant traction with the advent of container orchestration platforms like Kubernetes®. As organizations increasingly adopt microservices architectures, the complexity of managing applications and their components has escalated. Container orchestration platforms like Kubernetes® offer a framework for deployment, scaling, and management of containerized applications. However, the inherent complexity of the containerized applications needs the development of specialized tools and methodologies to streamline their management.

Operators are a key development in Kubernetes® technology that automates the management of apps and their components within a Kubernetes® cluster by utilizing custom resources. By utilizing the custom resources, the Operators offer an intuitive user interface that complements the resource-based interaction model of Kubernetes® and makes application management easier. Further, by using operator pattern, developers can increase Kubernetes®' capability without changing the core software, which encourages modularity and maintainability.

The capability of Kubernetes® is increased by associating controllers with one or more custom resources, which allows for the encapsulation of complex application lifecycle management tasks, such as deployment, scaling, and updates, ultimately enhancing the operational efficiency and resilience of the containerized applications. As a result, the Operators empower organizations to adopt declarative management practices, streamline DevOps workflows, and improve the overall reliability of their Kubernetes® environments.

The Operators find diverse applications across various domains, particularly in managing stateful applications, databases, and complex microservices architectures. For instance, the Operators are used to manage various components, such as databases and workflow engines, by encapsulating the operational logic needed for deployment and maintenance. This allows for seamless integration and management of complex applications, enabling organizations to leverage the full potential of Kubernetes®. Additionally, the Operators can be utilized to automate routine tasks, such as scaling, backups, and updates, thereby reducing the operational burden on development and operations teams. This automation not only enhances efficiency but also ensures that best practices are consistently applied across the application lifecycle.

Reconciliation is a fundamental component of the Kubernetes® reconciliation loop, designed to ensure that the actual state of a cluster aligns with the desired state, a task that Operators are specifically designed to perform. The process is triggered by events occurring on watched custom resources, prompting the reconciliation logic to evaluate the current state against the intended configuration. Each time an event is detected, the reconciliation function, using the Operator's custom logic, executes to determine whether the actual state matches the desired state. Depending on the outcome of this comparison, the reconciliation process may return a value indicating success or failure, with the Operators initiating corrective actions to bring the cluster back into alignment with the desired state. This mechanism is critical for maintaining the stability and reliability of Kubernetes environments, as Operators enable automated adjustments and self-healing capabilities, thereby enhancing operational efficiency and reducing the need for manual intervention.

Despite the numerous advantages and applications of the Operators, several challenges persist in their implementation and management. One significant issue arises when multiple Operators need to reconcile the same custom resource, leading to potential conflicts when modifying shared fields. For instance, in case both the Workflow and Decision components access the same PostgreSQL® custom resource fields, this can result in conflicting modifications.

A second challenge is the duplication of code logic across multiple Operators that manage the same custom resource. Each Operator may implement its reconciliation logic, leading to redundancy and increased maintenance overhead. This duplication not only complicates the development process but also makes it difficult to synchronize code changes across different teams and programming languages. As a result, maintaining consistent logic and handling conflicts becomes a significant challenge, particularly in large-scale deployments where multiple teams are responsible for developing their component Operators.

Finally, the complexity of deployments involving multiple custom resources further exacerbates these challenges. In such scenarios, various custom resources must be shared and managed cohesively. Each custom resource has its deployment logic, which can lead to inconsistencies and increased operational complexity. The need for a unified approach to managing these resources is critical to ensuring that deployments are efficient, reliable, and maintainable. Addressing these challenges is critical for organizations seeking to fully leverage the benefits of Kubernetes® Operators in their cloud-native application management strategies.

Traditional methods for resolution of conflicts rely on manual interventions which can lead to human error and inconsistencies, especially in dynamic environments like Kubernetes®. Further, the traditional methods may not scale effectively, as they can become cumbersome and inefficient when managing a large number of resources or complex dependencies, making the traditional methods time-consuming (by increasing the processing time) for the computing systems and the computing resources to perform reconciliation of the shared custom resources. The traditional methods rely on displaying the conflicts that arise during the reconciliation of the custom resource fields on a display device or in some cases on large display screens for providing the information about the conflicts and then obtaining an input for the resolution of the conflicts. Further, the computing systems must analyze (understand) the input and then resolve conflicts. Due to their complexity, the traditional methods increased the processing time of the computing systems and the computing resources for the resolution of the reconciliation requests and they further needed the use of high-end Graphics Processing units (GPUs) (for the analysis of the input and for displaying the conflicts on the display screens) that increases the overall cost of the process of resolution of the reconciliation requests. Therefore, there is a need for an approach to resolution of conflicts between the multiple operators during the reconciliation of the same custom resource.

The disclosed system provides a way for resolution of the conflicts that arise between the multiple operators during the reconciliation of the shared custom resource fields. The disclosed system provides an improved approach for resolving the conflicted reconciliation requests by limiting the manual interventions and removing inconsistencies in the resolution of the conflicted reconciliation requests. The disclosed system can be further scaled for large applications and the large number of resources, thereby solving the problems associated with the traditional methods.

The disclosed system provides an automated way for the resolution of the conflicted reconciliation requests by using a set of rules, thereby, eliminating the need for the computing system to display the conflicted reconciliation requests, obtain the input, analyze the input, and then resolve the conflicted reconciliation requests based on the analysis. Therefore, the disclosed system reduces the processing time of the computing system and the computing resources for the resolution of the conflicted reconciliation requests and the reconciliation of the shared custom resources by eliminating the need for the computing system to time and again display the conflicted reconciliation requests, obtain the input, understand and then perform the resolution of the conflicted reconciliation requests.

The disclosed system further eliminates the need for analysis (understanding) of the input and the need for displaying the conflicted reconciliation requests on large display screens, which in turn eliminates the need for the high-end GPUs that were needed by the traditional methods for the resolution. Therefore, the disclosed system further eliminates the need for high-end GPUs, and large computational resources for the resolution of the conflicted reconciliation requests and the reconciliation of the custom resource, thereby reducing the overall cost for the process of resolution of the conflicted reconciliation requests and the reconciliation of the shared custom resource.

In various embodiments of the disclosure, a computer-implemented method for resolution of reconciliation requests associated with a custom resource is described. The computer-implemented method includes retrieving, by a computer, one or more reconciliation requests associated with a custom resource from a data structure. The data structure includes a set of reconciliation requests associated with one or more custom resources. The one or more custom resources include the custom resource. The set of reconciliation requests includes the one or more reconciliation requests. The computer-implemented method further includes retrieving, by the computer, one or more rules from a set of rules for resolving the one or more reconciliation requests. The computer-implemented method further includes applying, by the computer, the one or more rules to the one or more reconciliation requests. The computer-implemented method further includes resolving, by the computer, the one or more reconciliation requests based on the application of the one or more rules. The computer-implemented method further includes outputting, by the computer, the resolved one or more reconciliation requests. The disclosed computer-implemented method automates the process of resolution of the one or more reconciliation requests by eliminating the need for manual interventions. Hence, the disclosed computer-implemented method eliminates the human error and inconsistencies, especially in dynamic environments like Kubernetes®. Furthermore, the disclosed computer-implemented method reduces the processing time of the computing system and the computing resources for the reconciliation of the shared custom resources by providing an automated way for the resolution of the conflicted reconciliation requests and eliminating the need for the computing system to time and again display the conflicted reconciliation requests, obtain the input, understand and then perform the resolution.

In various embodiments of the disclosure, the computer-implemented method further includes determining, by the computer, a priority order of the retrieved one or more reconciliation requests based on the application of the one or more rules to the retrieved one or more reconciliation requests. The computer-implemented method further includes arranging, by the computer, the retrieved one or more requests based on the priority order. The computer-implemented method further includes resolving, by the computer, the one or more reconciliation requests based on the arrangement. The disclosed computer-implemented method further eliminates the need for high-end GPUs by resolving the one or more reconciliation requests (the conflicted reconciliation requests) based on the priority order determined from the one or more rules and eliminating the need for analysis (understanding) of the input and the need for displaying the conflicted reconciliation requests on large display screens.

In various embodiments of the disclosure, the computer-implemented method further includes parsing, by the computer, the data structure. The computer-implemented method further includes retrieving, by the computer, the one or more reconciliation requests associated with the custom resource based on the parsing of the data structure. The disclosed computer-implemented method utilizes the generated data structure for detecting the one or more reconciliation requests (the conflicted reconciliation requests). Hence, the disclosed computer-implemented-method reduces the processing time of computing resources for detecting the one or more reconciliation requests in real time.

In various embodiments of the disclosure, the computer-implemented method further includes intercepting, by the computer, the set of reconciliation requests associated with the one or more custom resources. The computer-implemented method further includes determining, by the computer, a set of identifiers associated with the set of reconciliation requests. The computer-implemented method further includes generating, by the computer, the data structure based on the set of identifiers. The disclosed computer-implemented method includes generating and regularly maintaining the data structure for detecting the one or more reconciliation requests (conflicted requests). Hence, the disclosed computer-implemented method helps in maintaining a record of the set of reconciliation requests thereby ensuring that each reconciliation request of the set of reconciliation requests is processed and the overall result of the reconciliation process is accurate and consistent.

In various embodiments of the disclosure, each identifier of the set of identifiers corresponds to at least one of a custom resource creator value, a custom resource namespace, or a custom resource group. The disclosed computer-implemented method utilizes an identifier associated with each custom resource of the one or more custom resources to uniquely identify and correctly map each reconciliation request of the set of reconciliation requests to a corresponding custom resource of the one or more custom resources. Hence, the disclosed computer-implemented method reduces the possibility of errors in the reconciliation process by ensuring that each reconciliation request of the set of reconciliation requests is accurately mapped to the corresponding custom resource based on the identifier.

In various embodiments of the disclosure, the computer-implemented method further includes parsing, by the computer, the retrieved one or more reconciliation requests. The computer-implemented method further includes identifying, by the computer, the one or more rules from the set of rules based on the parsing of the retrieved one or more reconciliation requests. The computer-implemented method further includes retrieving, by the computer, the one or more rules from the set of rules based on the identification. The disclosed computer-implemented method includes parsing the one or more reconciliation requests to identify the one or more rules. Hence, the disclosed computer-implemented method ensures that only correct rules are retrieved from the set of rules that can resolve the one or more reconciliation requests which further ensures that the reconciliation process of the custom resource is accurately performed without any errors.

In various embodiments of the disclosure, the computer-implemented method further includes retrieving, by the computer, a configuration webhook that includes the set of rules. The computer-implemented method further includes retrieving, by the computer, the one or more rules from the set of rules based on the configuration webhook. The disclosed computer-implemented method includes retrieving the one or more rules from the configuration webhook which ensures that the one or more rules are retrieved from trusted sources. Hence, the disclosed computer-implemented method reduces the possibility of security threats and attacks.

In various embodiments of the disclosure, the computer-implemented method further includes parsing, by the computer, the resolved one or more reconciliation requests and a custom resource definition associated with the custom resource. The computer-implemented method further includes determining, by the computer, at least two reconciliation requests of the retrieved one or more reconciliation requests are unresolved upon the application of the one or more rules to the retrieved one or more reconciliation requests based on the parsing of the one or more reconciliation requests and the custom resource definition. The computer-implemented method further includes outputting, by the computer, the at least two reconciliation requests of the one or more reconciliation requests based on the determination that the at least two reconciliation requests are unresolved. In case the at least two reconciliation requests are still unresolved after the application of the one or more rules, the disclosed computer-implemented method includes detecting the at least two reconciliation requests that are still unresolved after the application of the one or more rules and outputting the at least two requests for the resolution. Hence, the disclosed computer-implemented method ensures that each reconciliation request of the one or more reconciliation requests is resolved which helps in accurately performing the reconciliation process of the custom resource.

In various embodiments of the disclosure, the computer-implemented method further includes receiving, by the computer, a priority order of the at least two reconciliation requests of the retrieved one or more reconciliation requests. The computer-implemented method further includes resolving, by the computer, the at least two reconciliation requests of the retrieved one or more reconciliation requests based on the received priority order. The disclosed computer-implemented method further includes resolving the at least two reconciliation requests (that are not resolved based on the application of the one or more rules) using the priority order. Hence, the disclosed computer-implemented method ensures that each reconciliation request of the one or more reconciliation requests is resolved which helps in accurately performing the reconciliation process of the custom resource.

In various embodiments of the disclosure, the computer-implemented method further includes controlling, by the computer, reconciliation of the custom resource based on the resolution of the one or more reconciliation requests. The computer-implemented method further includes outputting, by the computer, the reconciled custom resource. The disclosed computer-implemented method further includes controlling the reconciliation of the custom resource upon the resolution of the one or more reconciliation requests. Hence, the disclosed computer-implemented method provides a way for controlling the reconciliation of the shared custom resources by resolving the one or more reconciliation requests. Furthermore, the disclosed computer-implemented method reduces the overall processing time of computing resources for the reconciliation by starting the reconciliation just after resolution of the first reconciliation request of the one or more reconciliation requests (the conflicted requests) and hence reducing the idle time of the computing resources.

In various embodiments of the disclosure, the computer-implemented method further includes generating, by the computer, a reconciliation synchronization flag associated with the custom resource. The computer-implemented method further includes modifying, by the computer, the reconciliation synchronization flag. The computer-implemented method further includes controlling, by the computer, the reconciliation of the custom resource based on the modified reconciliation synchronization flag. The disclosed computer-implemented method includes controlling the reconciliation by the reconciliation synchronization flag. The reconciliation synchronization flag ensures that during the reconciliation of shared fields of the shared custom resource based on the first reconciliation request, the second reconciliation request of the one or more reconciliation requests will not be allowed to reconcile the shared field of the shared custom resource. Hence, the disclosed computer-implemented method ensures that the reconciliation is accurately performed, and the possibility of errors is minimized.

In various embodiments of the disclosure, the computer-implemented method further includes retrieving, by the computer, state information associated with the custom resource. The computer-implemented method further includes generating, by the computer, a first hash value of the state information associated with the custom resource. The computer-implemented method further includes retrieving, by the computer, a second hash value of the state information. The computer-implemented method further includes comparing, by the computer, the first hash value with the second hash value. The computer-implemented method further includes controlling, by the computer, the reconciliation of the custom resource based on the comparison. The disclosed computer-implemented method further includes comparing the first hash value and the second hash value to determine whether the custom resource needs reconciliation or not. Therefore, the disclosed computer-implemented method ensures that the computing power of the computing resources will only be utilized when needed for reconciliation. Hence, the disclosed computer-implemented method prevents the over-utilization of the computing power of the computing resources.

In various embodiments of the disclosure, the computer-implemented method further includes retrieving, by the computer, a mutant operand request webhook. The computer-implemented method further includes monitoring, by the computer, the resolved one or more reconciliation requests based on the mutant operand request webhook. The computer-implemented method further includes modifying, by the computer, at least one reconciliation request of the resolved one or more reconciliation requests based on the mutant operand request webhook. The disclosed computer-implemented method utilizes the mutant operand request webhook to identify the errors and misconfigurations in the one or more reconciliation requests that can affect the reconciliation of the custom resource. The disclosed computer-implemented method further includes modifying (or correcting) the errors and misconfigurations to ensure that the reconciliation is performed accurately, and the possibility of errors is minimized.

In various embodiments of the disclosure, a computer system for resolution of reconciliation requests associated with a custom resource is described. The computer system includes a processor set, one or more computer-readable storage media, and program instructions stored on the one or more computer-readable storage media. The program instructions are executable by the processor set and cause the processor set to intercept a reconciliation request associated with the custom resource. The reconciliation request is transmitted from a container operator associated with a container application hosted on a container platform. The program instructions further cause the processor set to arrange the reconciliation request into a data structure based on an identifier associated with the custom resource. The data structure includes a set of reconciliation requests associated with one or more custom resources. The one or more custom resources include the custom resource. The program instructions further cause the processor set to retrieve one or more reconciliation requests associated with the custom resource from the data structure. The one or more reconciliation requests include the reconciliation request. The set of reconciliation requests includes the one or more reconciliation requests. The program instructions further cause the processor set to retrieve one or more rules from a set of rules for resolving the one or more reconciliation requests. The program instructions further cause the processor set to apply the one or more rules to the one or more reconciliation requests. The program instructions further cause the processor set to resolve the one or more reconciliation requests based on the application of the one or more rules. The program instructions further cause the processor set to output the resolved one or more reconciliation requests. The disclosed computer system automates the process of resolution of the one or more reconciliation requests by eliminating the need for manual interventions. Hence, the disclosed computer system eliminates the human error and inconsistencies, especially in dynamic environments like Kubernetes®. Furthermore, the disclosed computer system reduces the processing time of the computing system and the computing resources for the reconciliation of the shared custom resources by providing an automated way for the resolution of the conflicted reconciliation requests and eliminating the need for the computing system to time and again display the conflicted reconciliation requests, obtain the input, understand and then perform the resolution.

In various embodiments of the disclosure, the program instructions further cause the processor set to determine a priority order of the one or more reconciliation requests based on the application of the one or more rules to the one or more reconciliation requests. The program instructions further cause the processor set to arrange the retrieved one or more reconciliation requests based on the determined priority order. The program instructions further cause the processor set to resolve the one or more reconciliation requests based on the arrangement. The disclosed computer system further eliminates the need for high-end GPUs by resolving the one or more reconciliation requests (the conflicted reconciliation requests) based on the priority order determined from the one or more rules and eliminating the need for analysis (understanding) of the input and the need for displaying the conflicted reconciliation requests on large display screens.

In various embodiments of the disclosure, the program instructions further cause the processor set to intercept the set of reconciliation requests associated with the one or more custom resources. The program instructions further cause the processor set to determine a set of identifiers associated with the set of reconciliation requests. The program instructions further cause the processor set to generate the data structure based on the set of identifiers. The disclosed computer system generates and regularly maintains the data structure for detecting the one or more reconciliation requests (conflicted requests). Hence, the disclosed computer system helps in maintaining a record of the set of reconciliation requests thereby ensuring that each reconciliation request of the set of reconciliation requests is processed and the overall result of the reconciliation process is accurate and consistent.

In various embodiments of the disclosure, the program instructions further cause the processor set to parse the retrieved one or more reconciliation requests. The program instructions further cause the processor set to identify the one or more rules from the set of rules based on the parsed one or more reconciliation requests. The program instructions further cause the processor set to retrieve the one or more rules from the set of rules based on the identification. The disclosed computer system parses the one or more reconciliation requests to identify the one or more rules. Hence, the disclosed computer system ensures that only correct rules are retrieved from the set of rules that can resolve the one or more reconciliation requests which further ensures that the reconciliation process of the custom resource is accurately performed without any errors.

In various embodiments of the disclosure, the program instructions further cause the processor set to parse the resolved one or more reconciliation requests, and a custom resource definition associated with the custom resource. The program instructions further cause the processor set to determine at least two reconciliation requests of the retrieved one or more reconciliation requests are unresolved upon the application of the one or more rules to the retrieved one or more reconciliation requests based on the parsed one or more reconciliation requests and the custom resource definition. The program instructions further cause the processor set to output the at least two reconciliation requests of the retrieved one or more reconciliation requests based on the determination that the at least two reconciliation requests are unresolved. In case the at least two reconciliation requests are still unresolved after the application of the one or more rules, the disclosed computer system detects the at least two reconciliation requests that are still unresolved after the application of the one or more rules and outputs the at least two requests for the resolution. Hence, the disclosed computer system ensures that each reconciliation request of the one or more reconciliation requests is resolved which helps in accurately performing the reconciliation process of the custom resource.

In various embodiments of the disclosure, the program instructions further cause the processor set to receive a priority order of the at least two reconciliation requests of the retrieved one or more reconciliation requests. The program instructions further cause the processor set to resolve the at least two reconciliation requests of the retrieved one or more reconciliation requests based on the received priority order. The disclosed computer system resolves the at least two reconciliation requests (that are not resolved based on the application of the one or more rules) using the priority order. Hence, the disclosed computer system ensures that each reconciliation request of the one or more reconciliation requests is resolved which helps in accurately performing the reconciliation process of the custom resource.

In various embodiments of the disclosure, a computer-program product for resolution of reconciliation requests associated with a custom resource is described. The computer program product includes one or more computer-readable storage media and program instructions stored in the one or more computer-readable storage media to perform operations that include retrieving one or more reconciliation requests associated with the custom resource from a data structure. The data structure includes a set of reconciliation requests associated with one or more custom resources. The set of reconciliation requests includes the one or more reconciliation requests. The one or more custom resources include the custom resource. The operations further include retrieving one or more rules from a set of rules for resolving the one or more reconciliation requests. The operations further include applying the one or more rules to the one or more reconciliation requests. The operations further resolving the one or more reconciliation requests based on the application of the one or more rules. The operations further include outputting the resolved one or more reconciliation requests. The disclosed computer-program product automates the process of resolution of the one or more reconciliation requests by eliminating the need for manual interventions. Hence, the disclosed computer-program product eliminates the human error and inconsistencies, especially in dynamic environments like Kubernetes®. Furthermore, the disclosed computer-program product reduces the processing time of the computing system and the computing resources for the reconciliation of the shared custom resources by providing an automated way for the resolution of the conflicted reconciliation requests and eliminating the need for the computing system to time and again display the conflicted reconciliation requests, obtain the input, understand and then perform the resolution.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

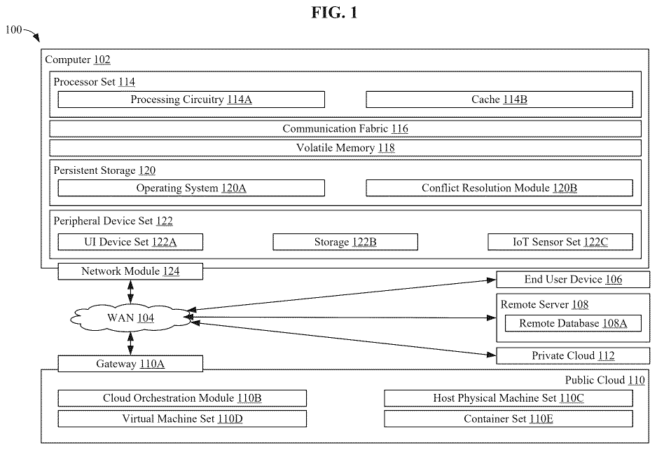

FIG. 1 is a diagram that illustrates a computing environment for resolution of reconciliation requests associated with a custom resource, in accordance with an embodiment of the disclosure. With reference to FIG. 1, there is shown a computing environment 100 that contains an example of an environment for the execution of at least some of the computer code involved in performing the disclosed methods, such as a conflict resolution module 120B. In addition to the conflict resolution module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the conflict resolution module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or a wearable computer, a mainframe computer, a quantum computer, or any various forms of a computer or a mobile device now known or to be developed in the future that can run a program, access a network or query a database, such as a remote database 108A. As is well understood in the art of computer technology, and depending upon the technology, the performance of a computer-implemented method may be distributed among multiple computers and/or between multiple locations. In this presentation of the computing environment 100, detailed discussion is focused on a single computer, specifically the computer 102, to keep the presentation as simple as possible. The computer 102 may be located in a cloud, even though it is not shown in a cloud in FIG. 1.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the various storage media discussed below. The program instructions, and associated data, are accessed by the processor set 114 to control and direct the performance of the disclosed methods. In computing environment 100, at least some of the instructions for performing the disclosed methods may be stored in the dynamic modification of the conflict resolution module 120B in the persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Various types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not needed unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the conflict resolution module 120B typically includes at least some of the computer code involved in performing the disclosed methods.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is needed to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows computer 102 to communicate with various computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) for communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows the public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

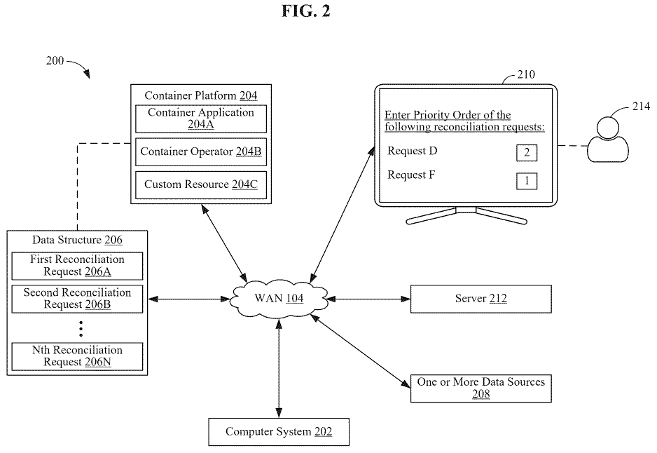

FIG. 2 is a diagram that illustrates an environment for resolution of reconciliation requests associated with a custom resource, in accordance with an embodiment of the disclosure. FIG. 2 is explained in conjunction with elements from FIG. 1. With reference to FIG. 2, there is shown a diagram of a network environment 200. The network environment 200 includes a computer system 202, a container platform 204, and a data structure 206. A container application 204A is hosted on the container platform 204. The container platform 204 further includes a container operator 204B and a custom resource 204C. The data structure 206 includes a set of reconciliation requests. The set of reconciliation requests includes a first reconciliation request 206A, a second reconciliation request 206B, up to a Nth reconciliation request 206N. The network environment 200 further includes one or more data sources 208, a user device 210, and a server 212. The user device 210 is further associated with a user 214 (a Development and Operations (DevOps) engineer). The network environment 200 further includes the WAN 104 of FIG. 1. In an embodiment of the disclosure, the user device 210 is an exemplary embodiment of the EUD 106. Similarly, the computer system 202 is an exemplary embodiment of the computer 102 in FIG. 1.

The computer system 202 retrieves one or more reconciliation requests that are associated with the custom resource 204C from the data structure 206. The data structure 206 includes the set of reconciliation requests associated with one or more custom resources. The one or more custom resources include the custom resource 204C. The set of reconciliation requests includes the one or more reconciliation requests. The computer system 202 further retrieves one or more rules from a set of rules to resolve the one or more reconciliation requests. The computer system 202 further applies the one or more rules to the one or more reconciliation requests. The computer system 202 further resolves the one or more reconciliation requests based on the application of the one or more rules to the one or more reconciliation requests. The computer system 202 further outputs the resolved one or more reconciliation requests.

Examples of the computer system 202 include but are not limited to, a server, a computing device, a virtual computing device, a mainframe machine, a computer workstation, a smartphone, a cellular phone, a mobile phone, a gaming device, or a consumer electronic (CE) device. By way of example, and not by limitation, the computer system 202 may be embodied as a cloud-based service, a cloud-based application, a cloud-based platform, a remote server-based service, a remote server-based application, a remote server-based platform, or a virtual computing system.

The container platform 204 includes suitable logic, circuitry, interfaces, and/or code that may be configured to host the container application 204A. Generally, the container platform 204 is a software framework that enables the deployment, management, and scaling of containerized applications. The container platform 204 provides a consistent runtime environment by encapsulating the container application 204A and the dependencies of the container application 204A within containers, ensuring seamless operation across various computing environments. These platforms offer tools and services for orchestrating containers, optimizing resource utilization, and automating tasks such as scaling and fault tolerance. Examples of different types of the container platform 204 include but are not limited to, container engines (such as Docker®), container orchestrators (such as the Kubernetes® and OpenShift®), and managed container platforms.

In an embodiment of the disclosure, the container application 204A is hosted on the container platform 204. Specifically, hosting the container application 204A on the container platform 204 involves several key steps to ensure it runs efficiently and reliably. Firstly, a docker file is created to define the environment of the container application 204A, dependencies, and relevant instructions to build the application image. The application image is then pushed to a container registry. Further, deployment configurations, typically using Yet Another Markup Language (YAML) files, are crafted to define the desired state of the application, specifying details such as the number of replicas, resource limits, and networking requirements. Such configurations are applied using container orchestration tools like Kubernetes®, which manage the deployment, scaling, and operation of the application containers across a cluster of nodes. Additional configurations might include setting up persistent storage, configuring environment variables and secrets for sensitive data, and setting up monitoring and logging to track the application's performance and health.

The container operator 204B includes suitable logic, circuitry code, or interfaces that are configured to manage the lifecycle of containerized applications within the container platform 204. The container operator 204B automates one or more tasks such as deployment, scaling, and monitoring of containers, ensuring that applications (the container application 204A) run smoothly and efficiently. By leveraging one or more custom resources (the custom resource 204C), the container operator 204B extends the capabilities of the container platform 204, allowing for tailored management of specific application requirements of the container application 204A. This might involve defining one or more custom resource definitions (CRDs) of the one or more custom resources that encapsulate the unique configurations and behaviors of the applications (the container application 204A) being hosted, enabling the container operator 204B to handle complex deployment scenarios and maintain desired states.

The container operator 204B continuously monitors the state of the container application 204A and the one or more custom resources (the custom resource 204C) and adjusts the state of applications as needed to meet performance and availability goals. For instance, if the container application 204A experiences increased traffic, the container operator 204B can automatically scale the number of container instances to accommodate the load. Additionally, the container operator 204B can implement self-healing mechanisms, such as restarting failed containers or rolling back to previous versions in case of deployment issues. Examples of the container operator 204B include but are not limited to, KubeVirt®, Argo CD®, OpenShift® operator framework, and the like.

The custom resource 204C includes suitable logic, circuitry code, or interfaces that are configured to extend the capabilities of the container platform 204. The custom resource 204C allows users to define and manage application-specific configurations of the container application 204A. By creating one or more custom resources, developers can encapsulate the unique requirements of their applications, enabling the orchestration system to understand and manage these resources. This abstraction allows for more complex and tailored deployments, as well as improved automation and lifecycle management of applications.

In an embodiment of the disclosure, the custom resource 204C may be added in a markup language file such as, but not limited to, a Yet Another Markup Language (YAML) file, Hypertext Markup Language (HTML) file, Extensible Hypertext Markup Language (XHTML) file, and XML Metadata Interchange (XML) file. The markup language file in the container application 204A hosted on the container platform 204 is a configuration file used to describe the requirements and settings of the container application 204A. In an embodiment of the disclosure, the container operator 204B can modify the configuration of the container application 204A by modifying the custom resource definition (CRD) of the custom resource 204C in the markup language file.

For example, a custom resource for a database of the container application 204A might define the specifications for a PostgreSQL® instance, including parameters such as storage size, replication settings, and backup schedules. The custom resource 204C can be defined in the YAML file as given below:

```
apiVersion: “PostgreSQL ®.example.com/v1”
kind: Postgres
metadata:
  name: my-postgres
  namespace: default
spec:
  replicas: 3
  storage:
    size: 10Gi
  connectionPool:
    maxConnections: 100
  resources:
    requests:
      cpu: “500m”
      memory: “512Mi”
    limits:
      cpu: “1”
      memory: “1Gi”
  parameters:
    shared_buffers: “64MB”
    max_connections: “80”
    transaction_isolation: “READ UNCOMMITTED”
    lock_timeout: 10 seconds
```

The data structure 206 corresponds to an organized collection of data that may be configured to store the set of reconciliation requests. The data structure 206 stores the first reconciliation request 206A, the second reconciliation request 206B, up to the Nth reconciliation request 206N. In an embodiment of the disclosure, the data structure maps each reconciliation request of the set of reconciliation requests to a corresponding custom resource of the one or more custom resources of the container application 204A. Specifically, the data structure 206 maps each reconciliation request of the set of reconciliation requests to a corresponding identifier of the corresponding custom resource. In this manner, the data structure stores a set of identifiers of the one or more custom resources and the set of reconciliation requests as a set of unique key-value pairs. Examples of the data structure 206 include but are not limited to a hash map, a dictionary, a map, an ordered dictionary, and the like.

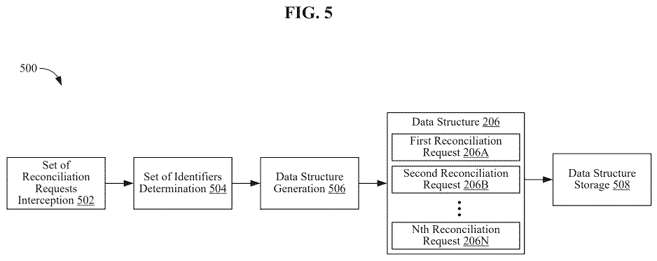

In an embodiment of the disclosure, the computer system 202 generates the data structure 206. Specifically, the computer system 202 intercepts the set of reconciliation requests transmitted from a plurality of operators of the container application 204A and retrieves the set of identifiers associated with the one or more custom resources to identify the set of unique key-value pairs and hence generate the data structure 206. For example, the computer system 202 intercepts the first reconciliation request 206A, the second reconciliation request 206B, up to the Nth reconciliation request 206N, and identifies the corresponding custom resource to generate the data structure. Details about the generation of the data structure are provided, for example, in FIG. 5.

Each reconciliation request of the set of reconciliation requests refers to a request associated with a reconciliation process by which the container operator 204B ensures that the actual state of the custom resource 204C matches the desired state as defined in the custom resource definition (CRD) of the custom resource 204C. When the custom resource 204C is created or modified, the container operator 204B transmits a reconciliation request, prompting it to evaluate the current state of the custom resource 204C and take relevant actions to align the custom resource 204C with the desired specifications as defined in the CRD.

For instance, if the number of replicas and resource limits of a custom resource for a web application are defined in the CRD of the custom resource, the container operator 204B monitors the actual deployment of the web application. If the number of running instances falls below the desired count, the container operator 204B will trigger the reconciliation request to scale up the deployment by creating additional pods. Conversely, if the resource limits are overutilized, the container operator 204B may trigger the reconciliation request to adjust the resource allocation. This continuous loop of monitoring and adjusting ensures that the container application 204A remains in the desired state, providing reliability and consistency in managing the one or more custom resources.

Each data source of the one or more data sources 208 corresponds to an organized collection of data that may be stored and accessed electronically from a computer system (such as the computer system 202). Each of the one or more data sources 208 may be designed to manage, store, retrieve, and update data efficiently. In an exemplary implementation, each data source of the one or more data sources 208 may correspond to a database. In such an implementation, the structure of the database corresponding to each data source of the one or more data sources 208 typically involves tables, records, and fields that can be managed through various database management systems (DBMS).

In an embodiment of the disclosure, each data source of the one or more data sources 208 stores a configuration webhook of the container application 204A hosted on the container platform 204. The configuration webhook of the application further includes specific configurations of the container application 204A and a set of rules. The set of rules includes a set of general instructions and a set of specific instructions for managing the lifecycle of the container application 204A and for ensuring a smooth run of the container application 204A. In an embodiment of the disclosure, the one or more data sources 208 are connected with the application programming interfaces (APIs) of the container application 204A hosted on the container platform 204. Examples of each data source of one or more data sources 208 may include but are not limited to, a relational database, a Non-Structured Query Language (SQL) database, a hierarchical database, a network database, a transactional database, a data warehouse, and a distributed database.

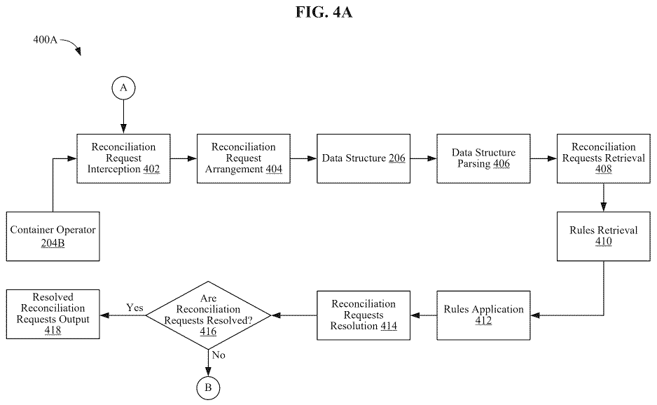

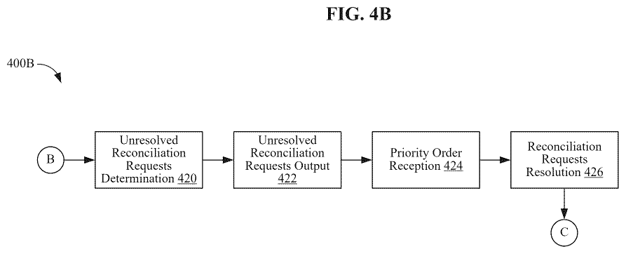

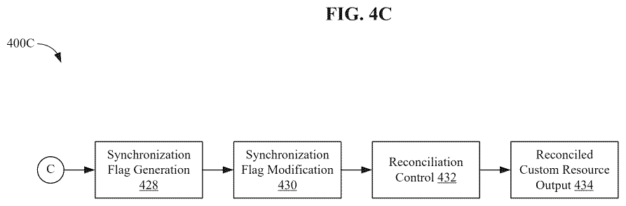

The user device 210 includes suitable logic, circuitry, and/or interfaces that are configured to execute one or more tasks within the network environment 200. The user device 210 performs the one or more tasks such as receiving data, processing the data, and transmitting the data. In an embodiment of the disclosure, the computer system 202 renders the resolved one or more reconciliation requests on the user device 210. In an alternate embodiment of the disclosure, the computer system 202 receives a priority order from the user device 210. Details about the reception of the priority order are provided, for example, in FIG. 4B. Examples of the user device 210 include one but are not limited to, a smartphone, a cellular phone, a mobile phone, a consumer electronic (CE) device, an Internet of Things (IOT) device, a computing device, a mainframe machine, a server, a computer workstation, or the like.

The server 212 includes suitable logic, circuitry, interfaces, and/or code that stores the first set of rules. The server 212 can be implemented as a cloud server and may execute operations through web applications, cloud applications, HTTP requests, repository operations, file transfer, and the like. Various example implementations of the server 212 include but are not limited to, a database server, a file server, a web server, a media server, an application server, a mainframe server, or a cloud computing server.

In an embodiment of the disclosure, the server 212 is implemented as a plurality of distributed cloud-based resources by use of several technologies that are well known to those ordinarily skilled in the art. A person with ordinary skill in the art will understand that the scope of the disclosure may not be limited to the implementation of the server 212 and the computer system 202 as two separate entities. In certain embodiments, the functionalities of the server 212 can be incorporated in its entirety or at least partially in the computer system 202, without a departure from the scope of the disclosure.

In operation, the computer system 202 retrieves a reconciliation request (the first reconciliation request 206A) associated with the custom resource 204C. The computer system 202 retrieves the first reconciliation request 206A from the data structure 206. As discussed above, the data structure 206 is generated by intercepting the set of reconciliation requests associated with the one or more custom resources of the container application 204A.

In an alternate embodiment of the disclosure, the computer system 202 intercepts the first reconciliation request 206A. The first reconciliation request 206A may be transmitted from the container operator 204B of the container application 204A hosted on the container platform 204. Details about the reconciliation request interception are provided, for example, in FIG. 4A.

By way of example, and not by limitation, the computer system 202 retrieves the first reconciliation request 206A associated with a PostgreSQL® custom resource. The first reconciliation request is transmitted from a workflow operator of the container application 204A. The first reconciliation request is associated with the reconciliation of the one or more fields of the PostgreSQL® custom resource as shown in Table 1 below:

TABLE 1
First Reconciliation Request

| Custom Resource Field | Current Value | Value after reconciliation |
|---|---|---|
| “max_connections” | 80 | 200 |
| “shared_buffers” | 64 MB | 256 MB |

Thereafter, the computer system 202 retrieves the one or more reconciliation requests that are associated with the custom resource 204C. The computer system 202 retrieves the one or more reconciliation requests from the data structure 206. The one or more reconciliation requests include at least the first reconciliation requests. Specifically, the computer system 202 parses the data structure 206 to retrieve the one or more reconciliation requests from the data structure 206.

By way of example, and not by limitation, the computer system 202 retrieves the first reconciliation request 206A and a second reconciliation request 206B associated with the PostgreSQL® custom resource from the data structure 206. The second reconciliation request 206B may be associated with a decision operator of the PostgreSQL® custom resource. The second reconciliation request 206B is associated with the reconciliation of the one or more fields of the PostgreSQL® custom resource as shown in Table 2 below:

TABLE 2
Second Reconciliation Request

| Custom Resource Field | Current Value | Value after reconciliation |
|---|---|---|
| “max_connections” | 80 | 100 |
| “shared_buffers” | 64 MB | 512 MB |

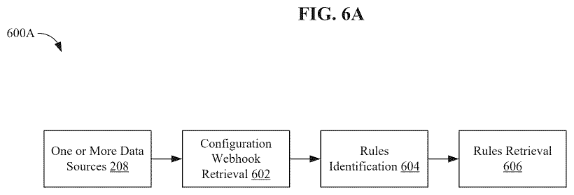

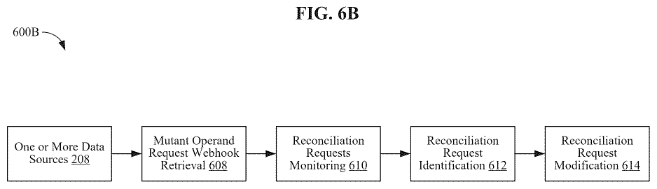

Further, the computer system 202 retrieves the one or more rules from the set of rules for resolving the one or more reconciliation requests. Specifically, the computer system 202 retrieves the configuration webhook of the container application 204A from the one or more data sources 208. The configuration webhook includes the set of rules. The computer system then retrieves the one or more rules from the configuration webhook. As discussed above, the one or more data sources 208 are connected with the APIs of the container application 204A hosted on the container platform 204. In an embodiment of the disclosure, the computer system 202 retrieves the one or more rules via the API calls. Details about the configuration webhook are further provided, for example, in FIG. 6A.

In an embodiment of the disclosure, the computer system 202 parses the retrieved one or more reconciliation requests and the custom resource definition (CRD) of the custom resource 204C. The computer system 202 parses the retrieved one or more reconciliation requests and the CRD to identify one or more conflicting fields of the custom resource 204C that need to be reconciled based on the one or more reconciliation requests. The computer system 202 further identifies the one or more rules corresponding to the one or more conflicting fields from the set of rules.

By way of example, and not by limitation, the computer system 202 identifies the one or more rules for resolving the one or more conflicting fields of the PostgreSQL® custom resource. The one or more rules can be shown in the Table 3 below:

TABLE 3
One or More Rules

| Custom Resource | |
|---|---|
| Field | Corresponding Rule |
| “max_connections” | Prioritize the request with the highest |
| | “max_connections” value |
| “shared_buffers” | For “shared_buffers”, prioritize the request with the |
| | highest value |

Thereafter, the computer system 202 applies the one or more rules to the retrieved one or more reconciliation requests. In an embodiment of the disclosure, the computer system 202 applies the one or more rules to resolve the one or more reconciliation requests and resolve the one or more conflicting fields of the custom resource 204C. Specifically, the computer system 202 applies each rule of the one or more rules to a corresponding conflicting field of the one or more conflicting fields of the custom resource 204C.

By way of example, and not by limitation, the computer system 202 applies the rule 1 “Prioritize the request with the highest “max_connections” value” to the conflicting field “max_connections” and the rule 2 “For “shared_buffers”, prioritize the request with the highest value” to the conflicting field “shared_buffers”.

Further, the computer system 202 resolves the one or more reconciliation requests based on the application of the one or more rules to the one or more reconciliation requests. In an embodiment of the disclosure, the computer system 202 resolves the one or more reconciliation requests associated with each conflicting field of the one or more conflicting fields based on the application of the corresponding rule of the one or more rules. Specifically, the computer system 202 resolves the one or more reconciliation requests by giving priority to the first reconciliation request 206A over the second reconciliation request 206B based on the application of the one or more rules or vice versa.

By way of example, and not by limitation, the computer system 202 resolves the conflicting field “max_connections” by giving priority to the first reconciliation request 206A since it has a greater “max_connections” reconciled value “200” based on the application of the rule 1. The computer system 202 further resolves the conflicting field “shared_buffers” by giving priority to the second reconciliation request 206B since it has a greater “shared_buffers” value “512 MB” based on the application of rule 2.

To this end, the computer system 202 outputs the resolved one or more reconciliation requests. In an embodiment of the disclosure, the computer system 202 renders the resolved one or more reconciliation requests on the user device 210. In an alternate embodiment of the disclosure, the computer system 202 renders the reconciled custom resource 204C on the user device 210 based on the resolution of the one or more reconciliation requests. By way of example, and not by limitation, the reconciled custom resource fields of the PostgreSQL® custom resource are shown in Table 4 below:

TABLE 4
Reconciled Custom Resource Fields

| Custom Resource Field | Previous Value | Reconciled Value |
|---|---|---|
| “max_connections” | 80 | 200 |
| “shared_buffers” | 64 MB | 512 MB |

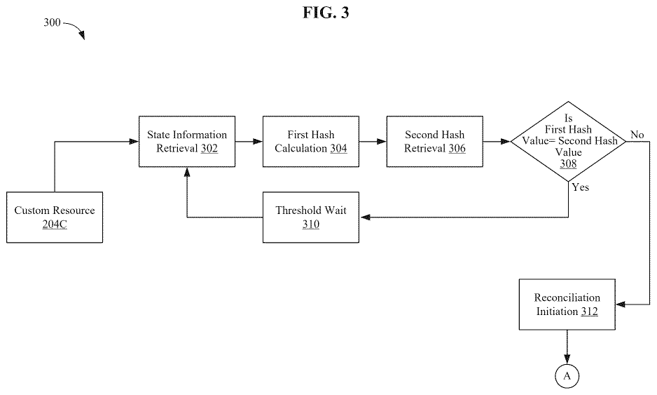

FIG. 3 is a diagram that illustrates exemplary operations for initiation of reconciliation of a custom resource for resolution of reconciliation requests, in accordance with an embodiment of the disclosure. FIG. 3 is explained in conjunction with elements from FIG. 1 and FIG. 2. With reference to FIG. 3, there is shown the block diagram 300 that illustrates exemplary operations from 302 to 312, as described herein. The exemplary operations illustrated in the block diagram 300 start at 302 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 300 can be divided into additional blocks, combined into fewer blocks, or eliminated, depending on the implementation.

At 302, a state information retrieval operation is performed. In the state information retrieval operation, the computer system 202 retrieves state information associated with the custom resource 204C. In an embodiment of the disclosure, the computer system 202 retrieves the state information from the one or more data sources 208. The state information associated with the custom resource 204C refers to the information about current configurations and the status of the custom resource 204C. The state information includes one or more specifications such as a number of replicas, resource limits, and various parameters (the various custom resource fields defined in the YAML files) that inform the current configurations and status of the custom resource 204C. The state information is critical for monitoring and managing the custom resource 204C effectively, ensuring that it meets the application's requirements.

By way of example, and not by limitation, the state information associated with the PostgreSQL® custom resource includes details such as the current number of active replicas, the status of each instance (e.g., running, failed), one or more storage utilization parameters, one or more connection metrics, and any ongoing operations like backups or upgrades. Additionally, the state information further includes one or more metrics of query performance and error rates, as well as configurations like the current PostgreSQL® version and one or more custom settings.

At 304, a first hash calculation operation is performed. In the first hash calculation operation, the computer system 202 calculates (or generates) a first hash value of the state information associated with the custom resource 204C. A hash value is a fixed-size string of characters generated by a hash function that may uniquely represent the contents of code (such as the state information or a specific file). In an embodiment of the disclosure, the computer system 202 applies the hash function to the state information to calculate the first hash value.

In an embodiment of the disclosure, the computer system 202 applies one of a Message Digest Algorithm 5 (MD5), or a Secure Hash Algorithm 256-bit (SHA-256) to the state information to calculate the first hash value. Details about the MD5 algorithm and the SHA-256 algorithm are known in the art and have been omitted for the sake of brevity.

At 306, a second hash retrieval operation is performed. In the second hash retrieval operation, the computer system 202 retrieves a second hash value associated with the custom resource 204C. In an embodiment of the disclosure, the computer system 202 retrieves the second hash value from the custom resource definition (CRD) of the custom resource 204C. Specifically, the computer system 202 retrieves the second hash value from the one or more data sources 208 via the API calls.

By way of example, and not by limitation, in case the traffic of a web application hosted on the cloud platform is increased, then one or more parameters such as database size or resource limits in the custom resource definition (CRD) of the custom resource 204C are updated. Due to this update, the second hash value stored in the CRD of the custom resource 204C is updated accordingly but this further needs to be replicated in the existing state information of the custom resource 204C. The computer system 202 further compares the first hash value with the second hash value to detect this change.

At 308, it is determined whether the first hash value is equal to the second hash value. In an embodiment of the disclosure, the computer system 202 compares the first hash value with the second hash value. The computer system 202 further determines whether the second hash value is equal to the first hash value or not based on the comparison. Based on the determination that the first hash value is equal to the second hash value, the control of operations proceeds to 310, otherwise the control of operations proceeds to 312.

At 310, a threshold wait operation is performed. In the threshold wait operation, the computer system 202 waits for a first threshold time period before repeating the operations from 302 to 308. The first threshold time period can be one of for example but not limited to, 15 seconds, 30 seconds, 45 seconds, or the like. The computer system 202 further repeats the operations from 302 to 308 to detect any further changes that need to be replicated in the current state of the custom resource 204C.

At 312, a reconciliation initiation operation is performed. In the reconciliation initiation operation, the computer system 202 initiates the reconciliation based on the determination that the first hash value is not equal to the second hash value. In an embodiment of the disclosure, the computer system 202 controls the reconciliation of the custom resource 204C based on the comparison. In case the first hash value is not equal to the second hash value, the difference between the first hash value and the second hash value indicates that one or more reconciliation operations need to be performed to ensure that the changes are replicated in the current state of the custom resource 204C.

In an embodiment of the disclosure, the computer system 202 controls the reconciliation based on the determination that the first hash value is not equal to the second hash value. A set of container operators (including the container operator 204B) of the container application 204A hosted on the container platform 204 further transmits a set of reconciliation requests to reconcile the custom resource 204C based on the determination that the first hash value is not equal to the second hash value. Details about the reconciliation control are further provided, for example, in FIG. 4A, FIG. 4B, and FIG. 4C.

FIG. 4A is a diagram that illustrates first exemplary operations for resolution of reconciliation requests associated with a custom resource, in accordance with an embodiment of the disclosure. FIG. 4A is explained in conjunction with elements from FIG. 1, FIG. 2, and FIG. 3. With reference to FIG. 4A, there is shown the block diagram 400A that illustrates exemplary operations from 402 to 418, as described herein. The exemplary operations illustrated in the block diagram 400A start at 402 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 400A can be divided into additional blocks, combined into fewer blocks, or eliminated, depending on the implementation.

At 402, a reconciliation request interception operation is performed. In the reconciliation request interception operation, the computer system 202 intercepts the first reconciliation request 206A associated with the custom resource 204C. The first reconciliation request 206A is transmitted from the container operator 204B. In an alternate embodiment of the disclosure, the computer system 202 retrieves the first reconciliation request 206A from the data structure 206 as discussed above.

By way of example, and not by limitation, the computer system 202 intercepts the first reconciliation request 206A associated with the PostgreSQL® custom resource. The first reconciliation request is transmitted from a workflow operator of the container application 204A. The first reconciliation request is associated with the reconciliation of the one or more fields of the PostgreSQL® custom resource as shown in Table 5 below:

TABLE 5
First Reconciliation Request

| Custom Resource Field | Current Value | Value after reconciliation |
|---|---|---|
| “max_connections” | 80 | 200 |
| “shared_buffers” | 64 MB | 256 MB |
| “transaction_isolation” | “READ UNCOMMITTED” | “READ COMMITTED” |
| “lock_timeout” | 10 seconds | 15 seconds |

At 404, a reconciliation request arrangement operation is performed. In the reconciliation request arrangement operation, the computer system 202 arranges the first reconciliation request 206A into the data structure 206. In an embodiment of the disclosure, the computer system 202 arranges the first reconciliation request 206A into the data structure 206 based on an identifier associated with the custom resource 204C. The identifier of the custom resource 204C is a unique value or a label that distinguishes the custom resource 204C from various custom resources (the one or more custom resources) associated with the container application 204A.

As discussed above, the data structure 206 includes the set of key-value pairs in which each reconciliation request of the set of reconciliation requests is mapped to the corresponding identifier of the corresponding custom resource of the one or more custom resources of the container application 204A. Therefore, the computer system 202 arranges the first reconciliation request in the data structure 206 based on the identifier associated with the custom resource 204C.

In an embodiment of the disclosure, the identifier of the custom resource 204C corresponds to a custom resource creator value, a custom resource group, and a custom resource namespace. The custom resource creator value is a unique value assigned to the custom resource 204C during its creation distinguishes the custom resource 204C from the one or more custom resources. Specifically, each custom resource of the one or more custom resources is grouped into one or more groups, and the first custom resource is also grouped into a group. For example, the PostgreSQL® custom resource is grouped into a first group of databases and a custom resource for messaging solutions can be grouped into a second group of messaging solutions. The custom resource namespace and the custom resource group distinguish the group of the custom resource 204C from the one or more groups of the one or more custom resources.

At 406, a data structure parsing operation is performed. In the data structure parsing operation, the computer system 202 parses the data structure 206. In an embodiment of the disclosure, the computer system 202 parses the data structure to identify the one or more reconciliation requests associated with the custom resource 204C. Specifically, the computer system 202 identifies the one or more reconciliation requests that are associated with reconciliation of the one or more conflicting fields of the custom resource 204C.

At 408, a reconciliation request retrieval operation is performed. In the reconciliation requests retrieval operation, the computer system 202 retrieves the one or more reconciliation requests from the data structure 206 based on the parsing. In an embodiment of the disclosure, the computer system 202 retrieves the identified one or more reconciliation requests that are associated with reconciliation of the one or more conflicting fields of the custom resource 204C.

By way of example, and not by limitation, the computer system 202 retrieves the second reconciliation request 206B and a third reconciliation request 206C associated with the PostgreSQL® custom resource from the data structure 206. The second reconciliation request 206B is associated with the decision operator of the PostgreSQL® custom resource. The third reconciliation request 206C is associated with a reporting operator of the PostgreSQL® custom resource. The second reconciliation request 206B and the third reconciliation request 206C are associated with the reconciliation of the one or more fields of the PostgreSQL® custom resource as shown in Table 6 and Table 7 below, respectively:

TABLE 6
Second Reconciliation Request

| Custom Resource Field | Current Value | Value after reconciliation |
|---|---|---|
| “max_connections” | 80 | 100 |
| “shared_buffers” | 64 MB | 512 MB |
| “lock_timeout” | 10 seconds | 30 seconds |

TABLE 7
Third Reconciliation Request

| Custom Resource Field | Current Value | Value after reconciliation |
|---|---|---|
| “max_connections” | 80 | 150 |
| “shared_buffers” | 64 MB | 128 MB |
| “transaction_isolation” | “READ UNCOMMITTED” | “SERIALIZABLE” |
| “lock_timeout” | 10 seconds | 45 seconds |

At 410, a rules retrieval operation is performed. In the rules retrieval operation, the computer system 202 retrieves the one or more rules from the set of rules for resolving the one or more reconciliation requests. Specifically, the computer system 202 retrieves the configuration webhook of the container application 204A from the one or more data sources 208. The configuration webhook includes the set of rules. The computer system then retrieves the one or more rules from the configuration webhook. As discussed above, the one or more data sources 208 are connected with the APIs of the container application 204A hosted on the container platform 204. In an embodiment of the disclosure, the computer system 202 retrieves the one or more rules via the API calls. Details about the configuration webhook are further provided, for example, in FIG. 6A.

In an embodiment of the disclosure, the computer system 202 parses the retrieved one or more reconciliation requests and the custom resource definition (CRD) of the custom resource 204C. The computer system 202 parses the one or more reconciliation requests and the CRD to identify one or more conflicting fields of the custom resource 204C that need to be reconciled based on the one or more reconciliation requests. The computer system 202 further identifies the one or more rules corresponding to the one or more conflicting fields from the set of rules.

By way of example, and not by limitation, the computer system 202 identifies the one or more rules for resolving the one or more conflicting fields of the PostgreSQL® custom resource. The one or more rules can be shown in the Table 8 below:

TABLE 8
One or More Rules

| Custom Resource Field | Corresponding Rule |
|---|---|
| “max_connections” | Prioritize the request with the highest |
| | “max_connections” value |
| “shared_buffers” | For “shared_buffers”, prioritize the request |
| | with the highest value |
| “lock_timeout” | Prioritize the request with the highest |
| | “lock_timeout” value |

At 412, a rules application operation is performed. In the rules application operation, the computer system 202 applies the one or more rules to the retrieved one or more reconciliation requests. In an embodiment of the disclosure, the computer system 202 applies the one or more rules to resolve the one or more reconciliation requests and resolve the one or more conflicting fields of the custom resource 204C. Specifically, the computer system 202 applies each rule of the one or more rules to a corresponding conflicting field of the one or more conflicting fields of the custom resource 204C.

By way of example, and not by limitation, the computer system 202 applies the rule 1 “Prioritize the request with the highest “max_connections” value” to the conflicting field “max_connections”, the rule 2 “For “shared_buffers”, prioritize the request with the highest value” to the conflicting field “shared_buffers”, the rule 3 “Prioritize the request with the highest “lock_timeout” value” to the conflicting field “lock_timeout”.

At 414, a reconciliation requests resolution operation is performed. In the reconciliation requests resolution operation, the computer system 202 resolves the one or more reconciliation requests based on the application of the one or more rules to the one or more reconciliation requests. In an embodiment of the disclosure, the computer system 202 resolves the one or more reconciliation requests associated with each conflicting field of the one or more conflicting fields of the custom resource 204C based on the application of the corresponding rule of the one or more rules.

In an embodiment of the disclosure, the computer system 202 determines a priority order based on the application of the one or more rules to the retrieved one or more reconciliation requests. Then, the computer system 202 arranges the retrieved one or more reconciliation requests based on the priority order and then resolves the one or more reconciliation requests based on the arrangement. Specifically, the computer system 202 resolves the one or more reconciliation requests by giving priority to one of the first reconciliation request 206A, the second reconciliation request 206B, or the third reconciliation request 206C for performing reconciliation of each conflicting field of the one or more conflicting fields based on the corresponding rule of the one or more rules.

By way of example, and not by limitation, the computer system 202 resolves the conflicting field “max_connections” by giving priority to the first reconciliation request 206A since it has the highest “max_connections” reconciled value “200” based on the application of the rule 1. The computer system 202 further resolves the conflicting field “shared_buffers” by giving priority to the second reconciliation request 206B since it has the highest “shared_buffers” value “512 MB” based on the application of rule 2. The computer system 202 further resolves the conflicting field “lock_timeout” by giving priority to the third reconciliation request 206C since it has the highest “lock_timeout” value “45 seconds” based on the application of the rule 3.

At 416, it is determined whether the one or more reconciliation requests are resolved. In an embodiment of the disclosure, the computer system 202 parses the resolved one or more reconciliation requests and the custom resource definition (CRD) to determine that each conflicting field of the one or more conflicting can be reconciled based on the one or more reconciliation requests. In an embodiment of the disclosure, the computer system 202 determines that each reconciliation request of the one or more reconciliation requests are resolved based on the determination that each conflicting field of the one or more conflicting can be reconciled.

Based on the determination that each reconciliation request of the one or more reconciliation requests is resolved, the control of operations proceeds to 418. The control of operations proceeds to 418 to output the one or more reconciliation requests and to solve the deadlock problem that existed in the reconciliation of the custom resource 204C. In an alternate embodiment of the disclosure, the computer system 202 further determines that at least two reconciliation requests of the one or more reconciliation requests are unresolved upon the application of the one or more rules to the retrieved one or more reconciliation requests based on the parsing of the resolved one or more reconciliation requests and the CRD.

Based on the determination that at least two reconciliation requests of the retrieved one or more reconciliation requests are unresolved, the control of operations proceeds to 420 (described in FIG. 4B). The control of operations proceeds to 420 to resolve the at least two reconciliation requests and to ensure that the deadlock problem in the reconciliation of the custom resource 204C is resolved. By way of example, and not by limitation, the computer system 202 determines that the first reconciliation request 206A associated with the conflicted field “transaction isolation” and the third reconciliation request 206C associated with the conflicted field “transaction isolation” are unresolved based on the application of the one or more rules. The control of operations proceeds to 420 for the resolution of the first reconciliation request 206A and the third reconciliation request 206C for the conflicted field that is unresolved based on the application of the one or more rules.

At 418, a resolved reconciliation requests output operation is performed. In the resolved reconciliation requests output operation, the computer system 202 outputs the resolved one or more reconciliation requests based on the determination that the one or more reconciliation requests are resolved. In an embodiment of the disclosure, the computer system 202 renders the resolved one or more reconciliation requests on the user device 210. In an alternate embodiment of the disclosure, the computer system 202 renders the reconciled custom resource 204C on the user device 210 based on the resolution of the one or more reconciliation requests. By way of example, and not by limitation, the reconciled custom resource fields of the PostgreSQL® custom resource are shown in Table 9 below:

TABLE 9
Reconciled custom resource fields

| Custom Resource Field | Previous Value | Reconciled Value |
|---|---|---|
| “max_connections” | 80 | 200 |
| “shared_buffers” | 64 MB | 512 MB |
| “lock_timeout” | 10 seconds | 45 seconds |

FIG. 4B is a diagram that illustrates second exemplary operations for resolution of reconciliation requests associated with a custom resource, in accordance with an embodiment of the disclosure. FIG. 4B is explained in conjunction with elements from FIG. 1, FIG. 2, FIG. 3, and FIG. 4A. With reference to FIG. 4B, there is shown the block diagram 400B that illustrates exemplary operations from 420 to 426, as described herein. The exemplary operations illustrated in the block diagram 400B start at 420 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 400B can be divided into additional blocks, combined into fewer blocks, or eliminated, depending on the implementation.

At 420, an unresolved reconciliation requests determination operation is performed. In the unresolved reconciliation requests determination operation, the computer system 202 determines (or identifies) the at least two reconciliation requests of the one or more reconciliation requests that are still unresolved upon the application of the one or more rules. The computer system 202 identifies the one or more reconciliation requests based on the parsed one or more reconciliation requests and the CRD. As discussed above at operation 416, the computer system 202 parses the one or more reconciliation requests and the CRD and determines that the at least two reconciliation requests are unresolved based on the parsed one or more reconciliation requests and the CRD.

By way of example, and not by limitation, the computer system 202 determines that the first reconciliation request 206A associated with the conflicted field “transaction isolation” and the third reconciliation request 206C associated with the conflicted field “transaction isolation” are unresolved based on the application of the one or more rules.

At 422, an unresolved reconciliation requests output operation is performed. In the unresolved reconciliation requests output operation, the computer system 202 outputs the at least two reconciliation requests. In an embodiment of the disclosure, the computer system 202 renders the at least two reconciliation requests on the user device 210. The computer system 202 renders the at least two reconciliation requests to obtain a priority order of the at least two reconciliation requests and resolve the at least two reconciliation requests so that the deadlock problem in the reconciliation of the custom resource 204C can be resolved.

By way of example, and not by limitation, the computer system 202 renders the first reconciliation request 206A associated with the conflicted field “transaction isolation” and the third reconciliation request 206C associated with the conflicted field “transaction isolation” to obtain the priority order.

At 424, a priority order reception operation is performed. In the priority order reception operation, the computer system 202 receives the priority order of the at least two reconciliation requests. In an embodiment of the disclosure, the computer system 202 receives the priority order from the user device 210. By way of example, and not by limitation, the computer system 202 receives the priority order that indicates prioritizing the third reconciliation request 206C over the first reconciliation request 206A in the reconciliation of the conflicted field “transaction isolation” of the custom resource 204C.

At 426, a reconciliation requests resolution operation is performed. In the reconciliation requests resolution operation, the computer system 202 resolves the at least two reconciliation requests based on the received priority order. The computer system 202 gives the priority to one reconciliation request of the at least two reconciliation requests for reconciling the custom resource 204C. The computer system 202 further controls the reconciliation of the custom resource 204C based on the resolution of the one or more reconciliation requests. Details about the reconciliation control operation are further provided, for example, in FIG. 4C.

By way of example, and not by limitation, the computer system 202 prioritizes the third reconciliation request 206C over the first reconciliation request 206A in reconciliation of the conflicted field “transaction isolation” of the custom resource 204C. The computer system 202 further reconciles the conflicted field “transaction isolation” from “READ UNCOMMITTED” to “SERIALIZABLE” based on the third reconciliation request 206C.

FIG. 4C is a diagram that illustrates exemplary operations for controlling reconciliation of a custom resource based on resolution of reconciliation requests, in accordance with an embodiment of the disclosure. FIG. 4C is explained in conjunction with elements from FIG. 1, FIG. 2, FIG. 3, FIG. 4A, and FIG. 4B. With reference to FIG. 4C, there is shown the block diagram 400C that illustrates exemplary operations from 428 to 434, as described herein. The exemplary operations illustrated in the block diagram 400C start at 428 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 400C can be divided into additional blocks, combined into fewer blocks, or eliminated, depending on the implementation.

At 428, a synchronization flag generation operation is performed. In the synchronization flag generation operation, the computer system 202 generates a reconciliation synchronization flag associated with the custom resource 204C. In an embodiment of the disclosure, the computer system 202 generates and appends the reconciliation synchronization flag to the custom resource definition (CRD) of the custom resource 204C. The reconciliation synchronization flag includes two statuses of the custom resource 204C as “standby” and “reconciling”. The “standby” status indicates that the custom resource 204C is currently not being reconciled and the “reconciling” status indicates that the custom resource 204C is currently being reconciled.

By way of example, and not by limitation, the computer system 202 generates the reconciliation synchronizaiton flag of the PostgreSQL® custom resource. The reconciliation synchronizaiton flag can be added in the YAML file as given below:

```
apiVersion: “PostgreSQL ®.example.com/v1”
kind: Postgres
metadata:
  name: my-postgres
  namespace: default
spec:
  replicas: 3
  storage:
    size: 10Gi
  connectionPool:
    maxConnections: 100
  resources:
    requests:
      cpu: “500m”
      memory: “512Mi”
    limits:
      cpu: “1”
      memory: “1Gi”
  parameters:
    shared_buffers: “64MB”
    max_connections: “80”
    transaction_isolation: “READ UNCOMMITTED”
    lock_timeout: 10 seconds
  status:
    reconciliation synchronization flag: standby
    manifestsMD5: 51552da31d9e9b3d072c60b80ae0fc3d
```

In an embodiment of the disclosure, the computer system 202 controls the reconciliation of the custom resource 204C based on the generated reconciliation synchronization flag. The computer system 202 reconciles each conflicting field of the one or more conflicting fields of the custom resource 204C based on the priority of the one or more reconciliation requests. By way of example and not by limitation, the computer system 202 reconciles the “max_connections” to “200” based on the first reconciliation request 206A. Similarly, the computer system 202 reconciles the “shared buffers” field, “lock committed” field, and the “transaction isolation field” based on the resolution of the one or more reconciliation requests using the reconciliation synchronization flag.

At 430, a synchronization flag modification operation is performed. In the synchronization flag modification operation, the computer system 202 modifies the reconciliation synchronization flag upon the reconciliation of the custom resource 204C based on the first reconciliation request 206A. The computer system 202 modifies the reconciliation field from “standby” to “reconciling” during the reconciliation of the custom resource 204C based on the corresponding reconciliation request of the one or more reconciliation requests. The computer system 202 further modifies the reconciliation field from “reconciling” to “standby” upon the completion of the reconciliation of the custom resource 204C based on the corresponding reconciliation request (the first reconciliation request 206A).

By way of example, and not by limitation, the computer system 202 modifies the reconciliation synchronization flag of the PostgreSQL® custom resource from “standby” to “reconciling” during the reconciliation of the “max_connections” to “200” based on the first reconciliation request 206A. Upon the completion of the reconciliation of the “max_connections”, the computer system 202 modifies the status back to “standby”. Similarly, the computer system 202 further modifies the reconciliation synchronization flag from “standby” to “reconciling” during reconciliation of the “shared buffers” to “512 MB”.

At 432, a reconciliation control operation is performed. In the reconciliation control operation, the computer system 202 controls the reconciliation of the custom resource 204C based on the reconciliation synchronization flag. In an embodiment of the disclosure, the computer system 202 controls the reconciliation of the custom resource 204C based on the second reconciliation request 206B using the modified reconciliation synchronization flag. Specifically, the computer system 202 suspends the second reconciliation request 206B when the first reconciliation request 206A is assigned the priority to reconcile the conflicting field of the custom resource 204C or vice versa. The computer system 202 further resumes the second reconciliation request 206B upon the completion of the reconciliation of the custom resource based on the first reconciliation request 206A or vice versa.

By way of example, and not by limitation, the computer system 202 reconciles the conflicting field “max_connections” to “200” based on the first reconciliation request 206A (priority based on the one or more rules). The computer system 202 further reconciles the conflicting field “shared_buffers” to “512 MB” based on the second reconciliation request (priority based on the one or more rules). The computer system 202 further reconciles the conflicting fields “lock_timeout” and the “transaction isolation” to “45 seconds” and “SERIALIZABLE” respectively, based on the third reconciliation request (priority based on the one or more rules and the received priority order respectively).

During each reconciliation operation, the computer system 202 iteratively modifies the reconciliation synchronization flag accordingly as described above, and then builds the reconciled custom resource (a final version custom resource) after the reconciliation. The reconciled custom resource can be given in the YAML file given below:

```
apiVersion: “PostgreSQL ®.example.com/v1”
kind: Postgres
metadata:
  name: my-postgres
  namespace: default
spec:
  replicas: 3
  storage:
    size: 10Gi
  connectionPool:
    maxConnections: 100
  resources:
    requests:
      cpu: “500m”
      memory: “512Mi”
    limits:
      cpu: “1”
      memory: “1Gi”
  parameters:
    shared_buffers: “512MB”
    max_connections: “200”
    transaction_isolation: “SERIALIZED”
    lock_timeout: 45 seconds
  status:
    reconciliation synchronization flag: standby
    manifestsMD5: 32241235da42d9e9b3d072c60b80ae0fc3d
```

In an alternate embodiment of the disclosure, the computer system 202 controls the reconciliation of the custom resource using a time-based trigger. The time-based trigger corresponds to a second threshold time period. The second threshold time period can be for example but not limited to, 5 minutes. The computer system 202 controls the reconciliation of the custom resource 204C based on the first reconciliation request 206A for the second threshold time period using the priority order and then suspends the first reconciliation request 206A. The computer system 202 further selects the second reconciliation request 206B based on the priority and similarly controls the reconciliation for the second threshold time period.

In case the first reconciliation request 206A completes the reconciliation before the second threshold time period, then the computer system 202 selects the second reconciliation request 206B to perform the reconciliation before the end of the second threshold time period. In this manner, the computer system 202 ensures that the deadlock problem associated with the reconciliation of the custom resource 204C is resolved and the container application 204A can run smoothly on the container platform 204.

At 434, a reconciled custom resource output operation is performed. In the reconciled custom resource output operation, the computer system 202 outputs the reconciled custom resource 204C. In an embodiment of the disclosure, the computer system 202 deploys the reconciled custom resource 204C on the container platform 204. In an alternate embodiment of the disclosure, the computer system 202 renders a message on the user device 210 that indicates that the custom resource is reconciled upon the resolution of the one or more reconciliation requests. By way of example, and not by limitation, the computer system 202 renders the message “Custom Resource A has been reconciled after the resolution of conflicts between request A, request B, request C, request D, request E, and request F”.

FIG. 5 is a diagram that illustrates exemplary operations for generation of a data structure for resolution of reconciliation requests associated with a custom resource, in accordance with an embodiment of the disclosure. FIG. 5 is explained in conjunction with elements from FIG. 1, FIG. 2, FIG. 3, FIG. 4A, FIG. 4B and FIG. 4C. With reference to FIG. 5, there is shown the block diagram 500 that illustrates exemplary operations from 502 to 508, as described herein. The exemplary operations illustrated in the block diagram 500 start at 502 and are performed by any computing system, apparatus, or device, such as by the computer 102 of FIG. 1 or by the computer system 202 of FIG. 2. With reference to FIG. 5, there is further shown the data structure 206. Although illustrated with discrete blocks, the exemplary operations associated with one or more blocks of the block diagram 500 can be divided into additional blocks, combined into fewer blocks, or eliminated, depending on the implementation.

At 502, a set of reconciliation requests interception operation is performed. In the set of reconciliation requests interception operation, the computer system 202 retrieves the set of reconciliation requests associated with the one or more custom resources (including the custom resource 204C) of the container application 204A hosted on the container platform 204. In an embodiment of the disclosure, the set of reconciliation requests is transmitted from the set of container operators (including the container operator 204B) associated with the container application 204A hosted on the cloud platform.

By way of example, and not by limitation, the computer system 202 intercepts the first reconciliation request 206A (say associated with a first custom resource), the second reconciliation request 206B (say associated with a second custom resource), up to the Nth reconciliation request (say associated with an Nth custom resource of the one or more custom resources of the container application 204A).

At 504, a set of identifiers determination operation is performed. In the set of identifiers determination operation, the computer system 202 determines a set of identifiers associated with the one or more custom resources. Each identifier of the set of identifiers is associated with a corresponding custom resource of the one or more custom resources. Each identifier of the set of identifiers is a unique value or a label that distinguishes the corresponding custom resource from various custom resources (the one or more custom resources) associated with the container application 204A.

In an embodiment of the disclosure, each identifier of the set of identifiers corresponds to a custom resource creator value, a custom resource group, and a custom resource namespace. The custom resource creator value is a unique value assigned to the corresponding custom resource during its creation that distinguishes the corresponding custom resource from the one or more custom resources. Specifically, each custom resource of the one or more custom resources is grouped into one or more groups. For example, the PostgreSQL® custom resource is grouped into a first group of databases and a custom resource for messaging solutions can be grouped into a second group of messaging solutions. The custom resource namespace and the custom resource group distinguish the group of the corresponding custom resource from the one or more groups of the one or more custom resources.

By way of example, and not by limitation, since the first reconciliation request 206A is associated with the first custom resource, the identifier associated with the first custom resource is say identifier “A”. Similarly, the identifier associated with the second custom resource (the second reconciliation request 206B) is say identifier “B”. Similarly, the identifier associated with the Nth custom resource (the Nth reconciliation request 206N) is say identifier “N”. In case the third reconciliation request 206C is also associated with the second custom resource, then the identifier associated with the third reconciliation request is also the identifier “B”.

At 506, a data structure generation operation is performed. In the data structure generation operation, the computer system 202 generates the data structure 206 based on the set of identifiers associated with the one or more custom resources. In an embodiment of the disclosure, the computer system 202 maps each reconciliation request of the set of reconciliation requests to the corresponding identifier of the set of identifiers associated with the corresponding custom resource of the one or more custom resources (the custom resource on which the reconciliation is performed based on the corresponding reconciliation request).

In an embodiment of the disclosure, the computer system 202 generates the set of key-value pairs. Each key (each reconciliation request) of the set of key-value pairs is mapped to a corresponding value (the corresponding identifier) of the set of key-value pairs. The data structure 206 includes the set of key-value pairs. The data structure 206 includes each intercepted reconciliation request of the set of reconciliation requests mapped to the corresponding identifier of the set of identifiers associated with the corresponding custom resource of the one or more custom resources.

By way of example, and not by limitation, the computer system 202 generates the data structure 206 shown in Table 10 below. As discussed above, since both the second reconciliation request and the third reconciliation request are associated with the second custom resource, both are mapped with the identifier “B”.

TABLE 10
Data Structure

| Reconciliation Request | Identifier | Custom Resource |
|---|---|---|
| First Reconciliation Request | A | First Custom Resource |
| Second Reconciliation | B | Second Custom Resource |
| Request | | |
| Third Reconciliation | B | Second Custom Resource |
| Request | | |
| . | . | . |
| . | . | . |
| . | . | . |
| Nth Reconciliation Request | N | Nth Custom Resource |

At 508, a data structure storage operation is performed. In the data structure storage operation, the computer system 202 stores the data structure 206 into the one or more data sources 208. In an alternate embodiment of the disclosure, the computer system 202 stores the data structure into the server 212. The computer system 202 regularly maintains and stores the data structure for detecting the one or more reconciliation requests (conflicted requests), thereby saving the time for the detection of the one or more reconciliation requests in real-time. The computer system 202 further stores the data structure 206 to maintain a record of the set of reconciliation requests, thereby ensuring that each reconciliation request of the set of reconciliation requests is processed by the computer system 202, and ensuring that the result of the reconciliation process is accurate and reliable.

FIG. 6A is a diagram that illustrates exemplary operations for retrieval of one or more rules for resolution of reconciliation requests associated with a custom resource, in accordance with an embodiment of the disclosure. FIG. 6A is explained in conjunction with elements from FIG. 1, FIG. 2, FIG. 3, FIG. 4A, FIG. 4B, FIG. 4C, and FIG. 5. With reference to FIG. 6A, there is shown the block diagram 600A that illustrates exemplary operations from 602 to 606, as described herein. The exemplary operations illustrated in the block diagram 600A start at 602 and are performed by any computing system, apparatus, or device, such as by the computer 102 of FIG. 1 or by the computer system 202 of FIG. 2. With reference to FIG. 6A, there is further shown the data structure 206. Although illustrated with discrete blocks, the exemplary operations associated with one or more blocks of the block diagram 600A can be divided into additional blocks, combined into fewer blocks, or eliminated, depending on the implementation.

At 602, a configuration webhook retrieval operation is performed. In the configuration webhook retrieval operation, the computer system 202 retrieves the configuration webhook of the container application 204A hosted on the cloud platform. The configuration webhook includes the set of rules for resolving the one or more reconciliation requests. In an embodiment of the disclosure, the computer system 202 retrieves the configuration webhook from the one or more data sources 208 via the API calls.

The configuration webhook corresponds to a webhook designed specifically to manage and enforce configurations across the one or more custom resources within the container platform 204. The configuration webhook further serves as an interface that allows an administrator to interact with the application hosted on the container platform 204, enabling the dynamic validation, mutation, and enforcement of the configurations of the one or more custom resources based on predefined rules and policies. The predefined rules and policies can be collectively referred to as the set of rules.

The set of rules may be utilized during the reconciliation of the one or more custom resources or more specifically, during the resolution of the one or more reconciliation requests by giving priority to a first request instead of a second request. By way of example, and not by limitation, the set of rules can be represented in Table 11 as given below:

TABLE 11
Set of Rules

| Key Aspect | Corresponding Rule |
|---|---|
| Resource | Prioritize requests that utilize fewer resources (e.g., |
| Utilization | lower memory or CPU usage) to maintain system |
| | performance. |
| Data Integrity | If a request violates data integrity constraints (like |
| | foreign key constraints), prioritize requests that |
| | maintain data integrity. |
| Request Source | Prioritize requests from high trusted sources over those |
| | from less trusted sources. |
| Request Type | Differentiate between types of requests (e.g., updates |
| | vs. inserts) and Prioritize update requests over insert |
| | requests to maintain the most current data versions. |
| User Role | Assign priority based on user roles, where |
| | administrators have higher priority than regular |
| | users. |
| Conflict Type | For conflicts involving the same data, prioritize based |
| | on the type of conflict (e.g., update conflicts may take |
| | precedence over delete conflicts). |
| Maximum | Prioritize the request with the highest Maximum |
| Connections | Connections. |
| Batch Processing | If multiple requests are received in a batch, prioritize |
| | based on the order of arrival, processing earlier |
| | requests first. |
| System Load | Monitor system load and prioritize requests during |
| | low-load periods. This can help maintain performance |
| | and responsiveness. |
| Time Complexity | Prioritize low-time complexity requests over high-time |
| | complexity requests. This can help streamline |
| | processing and reduce the time taken to resolve |
| | conflicts. |
| Shared Buffers | Prioritize the request with the highest Shared Buffers. |
| Data Size | Prioritize smaller data modifications over larger |
| | ones. This can help reduce the load on the system and |
| | improve overall performance. |
| Error Rate | Prioritize requests that have a lower error rate in |
| | previous executions. This can help maintain system |
| | stability by favoring requests that are less likely to |
| | cause issues. |
| Dependency | If a first request depends on the completion of a |
| Resolution | second request, prioritize the second request. |
| System | During scheduled maintenance windows, prioritize |
| Maintenance | requests that are critical to system functionality over |
| Window | routine requests. |
| Resource Type | Priority requests based on a hierarchy of request |
| Hierarchy | types (e.g., emergency requests > standard requests > |
| | informational requests) |
| Frequency of | Give priority to requests that involve frequently |
| Accessed Data | accessed data. This can help optimize performance by |
| | ensuring that popular data is updated or retrieved first. |
| Lock Timeout | Prioritize the request with the highest Lock Timeout. |

At 604, a rules identification operation is performed. In the rules identification operation, the computer system 202 identifies the one or more rules from the set of rules for resolving the one or more reconciliation requests. Specifically, the computer system 202 parses the one or more reconciliation requests to identify the one or more conflicting fields of the custom resource 204C. The computer system 202 further identifies the one or more rules from the set of rules corresponding to the one or more conflicting fields based on the parsing of the one or more reconciliation requests.

By way of example, the computer system 202 identifies the one or more rules from the set of rules for resolving the PostgreSQL® custom resource. The one or more rules can be shown in Table 12 below:

TABLE 12
One or More Rules

| Custom Resource Field | Corresponding Rule |
|---|---|
| Maximum Connections | Prioritize the request with the highest |
| | Maximum Connections. |
| Shared Buffers | Prioritize the request with the highest Shared |
| | Buffers. |
| Lock Timeout | Prioritize the request with the highest Lock |
| | Timeout. |

At 606, a rules retrieval operation is performed. In the rules retrieval operation, the computer system 202 retrieves the one or more rules based on the identification. The computer system 202 retrieves the identified one or more rules from the set of rules. In an embodiment of the disclosure, the computer system 202 retrieves the one or more rules from the configuration webhook associated with the container application 204A hosted on the container platform 204.

FIG. 6B is a diagram that illustrates exemplary operations for modification of a reconciliation request associated with a custom resource, in accordance with an embodiment of the disclosure. FIG. 6B is explained in conjunction with elements from FIG. 1, FIG. 2, FIG. 3, FIG. 4A, FIG. 4B, FIG. 4C, FIG. 5, and FIG. 6A. With reference to FIG. 6B, there is shown the block diagram 600B that illustrates exemplary operations from 608 to 614, as described herein. The exemplary operations illustrated in the block diagram 600B start at 608 and are performed by any computing system, apparatus, or device, such as by the computer 102 of FIG. 1 or by the computer system 202 of FIG. 2. With reference to FIG. 6B, there is further shown the data structure 206. Although illustrated with discrete blocks, the exemplary operations associated with one or more blocks of the block diagram 600B can be divided into additional blocks, combined into fewer blocks, or eliminated, depending on the implementation.

At 608, a mutant operand request webhook retrieval operation is performed. In the mutant operand request webhook retrieval operation, the computer system 202 retrieves a mutant operand request webhook associated with the container application 204A hosted on the container platform 204. In an embodiment of the disclosure, the computer system 202 retrieves the mutant operand request webhook from the one or more data sources 208. The mutant operand request webhook is a webhook that is utilized to mutate and validate the one or more reconciliation requests before the reconciliation of the custom resource 204C.

The mutant operand request webhook includes a set of validation criteria, which outline the conditions that the one or more reconciliation requests must meet to be considered valid. For instance, the computer system 202 further checks for specific labels, annotations, or specific field values in the one or more reconciliation requests that align with the custom resource definition. By establishing the set of validation criteria, the computer system 202 ensures that only trusted one or more reconciliation requests are utilized for reconciliation, thereby preventing potential misconfigurations that could impact the application performance or security of the container application 204A.

The mutant operand request webhook further includes an error repository associated with the container application 204A hosted on the container platform 204. The error repository may include a range of accepted values for the one or more fields of the one or more custom resources of the container application 204A. In case a value of any field in the one or more reconciliation requests is outside the range of accepted values, the computer system 202 modifies the field to keep it inside the range of accepted values.

At 610, a reconciliation requests monitoring operation is performed. In the reconciliation requests monitoring operation, the computer system 202 monitors the resolved one or more reconciliation requests based on the mutant operand request webhook. The computer system 202 monitors each reconciliation request of the resolved one or more reconciliation requests to validate the corresponding reconciliation request of the resolved one or more reconciliation requests based on the mutant operand request webhook.

The computer system 202 further monitors the resolved one or more reconciliation requests and determines whether a reconciliation request of the resolved one or more reconciliation requests can cause potential misconfigurations and errors to the custom resource 204C (and the one or more custom resources) based on the mutant operand request webhook. By way of example, and not by limitation, in case the “database hostname” is incorrect, the “image/repo tag” is incorrect, “DB user/password/certificate” stored in “db credential secret” is wrong, a network issue, a storage failure, or the like.

At 612, a reconciliation request identification operation is performed. In the reconciliation request identification operation, the computer system 202 identifies the reconciliation request from the resolved one or more reconciliation requests that can cause potential misconfigurations and errors to the custom resource 204C (and the one or more custom resources) based on the mutant operand request webhook and the monitoring of the one or more reconciliation requests.

By way of example, and not by limitation, the computer system 202 retrieves the YAML file having the database name inputted incorrectly as described below:

```
apiVersion: “PostgreSQL ®.example.com/v1”
kind: Postgres
metadata:
  name: xxxyyyy
  namespace: default
spec:
  replicas: 3
  storage:
    size: 10Gi
  connectionPool:
    maxConnections: 100
  resources:
    requests:
      cpu: “500m”
      memory: “512Mi”
    limits:
      cpu: “1”
      memory: “1Gi”
  parameters:
    shared_buffers: “512MB”
    max_connections: “200”
    transaction_isolation: “SERIALIZED”
    lock_timeout: 45 seconds
  status:
    reconciliation synchronization flag: standby
    manifestsMD5: 32241235da42d9e9b3d072c60b80ae0fc3d
```

At 614, a reconciliation request modification operation is performed. In the reconciliation request modification operation, the computer system 202 modifies (or mutates/corrects) the reconciliation request that can cause potential misconfigurations and errors to the custom resource 204C (and the one or more custom resources) based on the mutant operand request webhook (the error repository and the set of validation criteria of the mutant operand request webhook).

By way of example, and not by limitation, the computer system 202 modifies the YAML file having the database name inputted incorrectly to make it correct according to the mutant operand request webhook (“my-postgres”) as described below:

```
apiVersion: “PostgreSQL ®.example.com/v1”
kind: Postgres
metadata:
  name: my-postgres
  namespace: default
spec:
  replicas: 3
  storage:
    size: 10Gi
  connectionPool:
    maxConnections: 100
  resources:
    requests:
      cpu: “500m”
      memory: “512Mi”
    limits:
      cpu: “1”
      memory: “1Gi”
  parameters:
    shared_buffers: “512MB”
    max_connections: “200”
    transaction_isolation: “SERIALIZED”
    lock_timeout: 45 seconds
  status:
    reconciliation synchronization flag: standby
    manifestsMD5: 32241235da42d9e9b3d072c60b80ae0fc3d
```

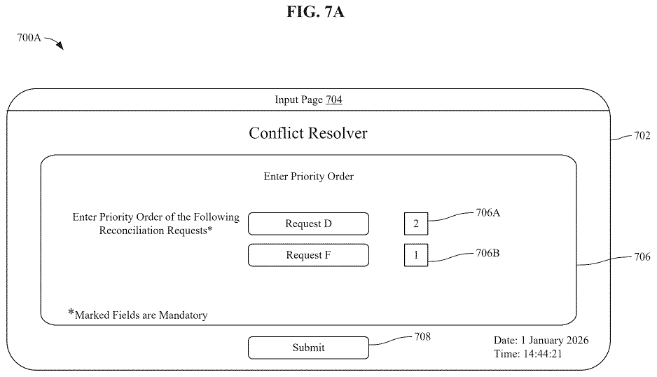

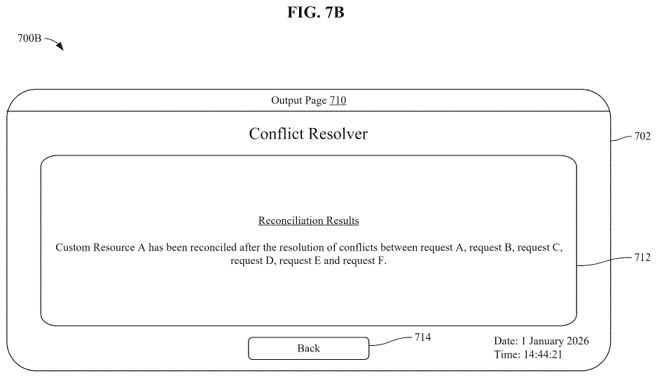

FIG. 7A is a diagram that illustrates an exemplary first user interface for resolution of reconciliation requests associated with a custom resource, in accordance with an embodiment of the disclosure. FIG. 7A is explained in conjunction with elements from FIG. 1, FIG. 2, FIG. 3, FIG. 4A, FIG. 4B, FIG. 4C, FIG. 5, FIG. 6A and FIG. 6B. With reference to FIG. 7A, there is shown an exemplary diagram 700A that includes a user device 702 and an input page 704. The input page 704 includes a first user interface (UI) element 706, a second UI element 706A, a third UI element 706B, and a fourth UI element 708. The user device 702 is an exemplary embodiment of the user device 210 of FIG. 2.

With reference to FIG. 7A, the computer system 202 renders the input page 704 on the user interface (UI) of the user device 702. The input page 704 corresponds to a web page or online form that is designed to collect information from the user (the administrator, or the DevOps engineer associated with the container platform). In an embodiment of the disclosure, the input page 704 is used to gather relevant details from the administrator for resolving the one or more reconciliation requests.

As discussed above, in case the at least two reconciliation requests of the one or more reconciliation requests are unresolved after the application of the one or more rules, then the computer system 202 renders the at least two reconciliation requests on the user device 210. Specifically, the computer system 202 renders the at least two reconciliation requests on the input page 704 of the user device 702 to obtain the priority order of the at least two reconciliation requests and then to resolve the one or more reconciliation requests.

The first UI element 706 corresponds to a textbox that includes a message for user 214, for example, “Enter Priority Order”. The first UI element 706 is used to obtain the priority order of the at least two reconciliation requests. The first UI element 706 further includes the second UI element 706A and the third UI element 706B. The second UI element 706A corresponds to a textbox. The second UI element 706A is used to obtain the priority order of the first reconciliation request 206A of the at least two reconciliation requests. For example, the computer system 202 obtains the priority order of the first reconciliation request as “2” in the at least two reconciliation requests.

The third UI element 706B corresponds to a textbox. The third UI element 706B is used to obtain the priority order of the second reconciliation request 206B of the at least two reconciliation requests. For example, the computer system 202 obtains the priority order of the second reconciliation request as “1” in the at least two reconciliation requests. The fourth UI element 708 corresponds to a button and is labeled as “Submit”. Upon selecting the fourth UI element 708, the computer system 202 receives the priority order, resolves the one or more reconciliation requests, and initiates the reconciliation of the custom resource 204C. Details about the resolution of the one or more reconciliation requests and the control of the reconciliation are provided, for example, in FIG. 4A, FIG. 4B, and FIG. 4C.

FIG. 7B is a diagram that illustrates an exemplary second user interface for resolution of reconciliation requests associated with a custom resource, in accordance with an embodiment of the disclosure. FIG. 7B is explained in conjunction with elements from FIG. 1, FIG. 2, FIG. 3, FIG. 4A, FIG. 4B, FIG. 4C, FIG. 5, FIG. 6A, FIG. 6B and FIG. 7A. With reference to FIG. 7B, there is shown an exemplary diagram 700B that includes the user device 702 and an output page 710. The output page 710 includes a fifth UI element 712 and a sixth UI element 714. The user device 702 is an exemplary embodiment of the user device 210 of FIG. 2.

With reference to FIG. 7B, the computer system 202 renders the output page 710 on the display unit (or the user interface) of the user device 702 based on the resolution of the one or more reconciliation requests and the reconciliation of the custom resource 204C. The computer system 202 renders the message on the output page 710 that indicates that the custom resource is reconciled upon the resolution of the one or more reconciliation requests.

The fifth UI element 712 corresponds to a textbox that includes the message that indicates that the custom resource is reconciled upon the resolution of the one or more reconciliation requests. By way of example, and not by limitation, the computer system 202 renders the message “Custom Resource A has been reconciled after the resolution of conflicts between request A, request B, request C, request D, request E, and request F”. The sixth UI element 714 corresponds to a button and is labeled as “Back”. Upon selecting the sixth UI element 714, the computer system 202 renders the input page 704 on the user device 702. The computer system 202 further renders specific reconciliation requests (that are associated with conflicting field of various custom resources of the one or more custom resources) on the input page 704 in case the specific reconciliation requests are not resolved based on the application of the one or more rules. The computer system 202 further similarly obtains the priority order of the specific reconciliation requests using the input page 704 and similarly resolves the specific reconciliation requests using the priority order. The specific reconciliation requests are exclusive of the at least two reconciliation requests.

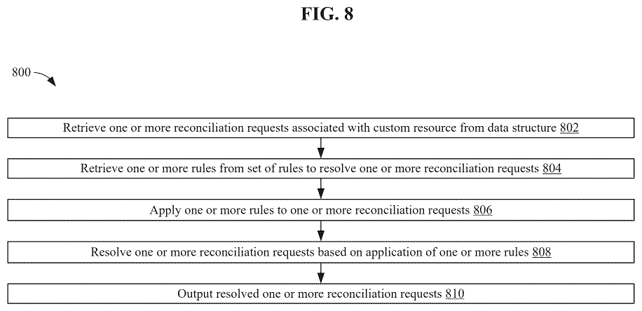

FIG. 8 is a diagram that illustrates a flowchart of a first exemplary method for resolution of reconciliation requests associated with a custom resource, in accordance with an embodiment of the disclosure. FIG. 8 is explained in conjunction with FIG. 1, FIG. 2, FIG. 3, FIG. 4A, FIG. 4B, FIG. 4C, FIG. 5, FIG. 6A, FIG. 6B, FIG. 7A, and FIG. 7B. With reference to FIG. 8, there is shown a flowchart 800. The operations of the exemplary method may be executed by any computing system, for example, by the computer 102 of FIG. 1 or the computer system 202 of FIG. 2. The operations of the flowchart 800 may start at 802.

At 802, the one or more reconciliation requests associated with the custom resource 204C are retrieved from the data structure 206. The data structure 206 includes the set of reconciliation requests associated with the one or more custom resources. The set of reconciliation requests includes the one or more reconciliation requests. The one or more custom resources include the custom resource 204C. In an embodiment of the disclosure, the computer system 202 retrieves the one or more reconciliation requests from the data structure 206 that are associated with the custom resource 204C. The data structure 206 includes the set of reconciliation requests associated with the one or more custom resources. The one or more custom resources include the custom resource 204C. The set of reconciliation requests includes the one or more reconciliation requests. Details about the one or more reconciliation request retrieval operation are provided, for example, in FIG. 2 and FIG. 4A. Details about the data structure generation operation are provided for example, in FIG. 5.

At 804, the one or more rules are retrieved from the set of rules to resolve the one or more reconciliation requests. In an embodiment of the disclosure, the computer system 202 retrieves the one or more rules from the set of rules to resolve the one or more reconciliation requests. Details about the one or more rules retrieval operation are provided, for example, in FIG. 2, FIG. 4A, and FIG. 6A.

At 806, the one or more rules are applied to the one or more reconciliation requests. In an embodiment of the disclosure, the computer system 202 applies the one or more rules to the one or more reconciliation requests. Details about the one or more rules application operation are provided, for example, in FIG. 2 and FIG. 4A

At 808, the one or more reconciliation requests are resolved based on the application of the one or more rules. In an embodiment of the disclosure, the computer system 202 resolves the one or more reconciliation requests based on the application of the one or more rules. Details about the reconciliation requests resolution operation are provided, for example, in FIG. 2, FIG. 4A, and FIG. 4B.

At 810, the resolved one or more reconciliation requests are outputted. In an embodiment of the disclosure, the computer system 202 outputs the resolved one or more reconciliation requests. Details about the reconciliation requests output operation are provided, for example, in FIG. 2 and FIG. 4A.

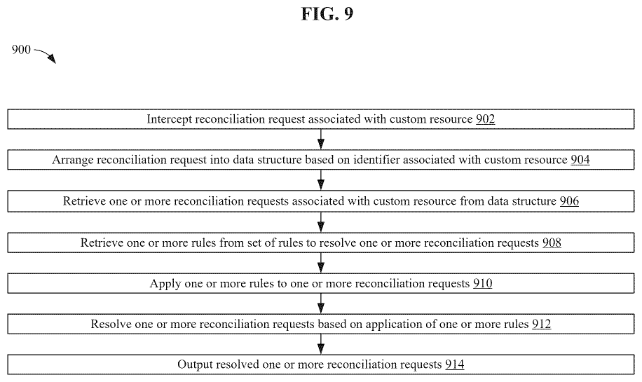

FIG. 9 is a diagram that illustrates a flowchart of a second exemplary method for resolution of reconciliation requests associated with a custom resource, in accordance with an embodiment of the disclosure. FIG. 9 is explained in conjunction with FIG. 1, FIG. 2, FIG. 3, FIG. 4A, FIG. 4B, FIG. 4C, FIG. 5, FIG. 6A, FIG. 6B, FIG. 7A, FIG. 7B, and FIG. 8. With reference to FIG. 9, there is shown a flowchart 900. The operations of the exemplary method may be executed by any computing system, for example, by the computer 102 of FIG. 1 or the computer system 202 of FIG. 2. The operations of the flowchart 900 may start at 902.

At 902, the reconciliation request (the first reconciliation request 206A) associated with the custom resource 204C is intercepted. The reconciliation request (the first reconciliation request 206A) is transmitted from the container operator 204B associated with the container application 204A hosted on the container platform 204. In an embodiment of the disclosure, the computer system 202 intercepts the reconciliation request (the first reconciliation request 206A) associated with the custom resource 204C. The reconciliation request (the first reconciliation request 206A) is transmitted from the container operator 204B associated with the container application 204A hosted on the container platform 204. Details about the reconciliation request interception are provided, for example, in FIG. 4A.

At 904, the reconciliation request (the first reconciliation request 206A) is arranged into the data structure 206 based on the identifier associated with the custom resource 204C. The data structure 206 includes the set of reconciliation requests associated with the one or more custom resources. The one or more custom resources include the custom resource 204C. In an embodiment of the disclosure, the computer system 202 arranges the reconciliation request (the first reconciliation request 206A) into the data structure 206 based on the identifier associated with the custom resource 204C. The data structure 206 includes the set of reconciliation requests associated with the one or more custom resources. The one or more custom resources include the custom resource 204C. Details about the arrangement of the first reconciliation requests and the data structure generation are provided, for example, in FIG. 4A and FIG. 5.

At 906, the one or more reconciliation requests that are associated with the custom resource 204C are retrieved from the data structure 206. The one or more reconciliation requests include at least the reconciliation request (the first reconciliation request 206A). The set of reconciliation requests includes the one or more reconciliation requests. In an embodiment of the disclosure, the computer system 202 retrieves the one or more reconciliation requests from the data structure 206 that are associated with the custom resource 204C. The one or more reconciliation requests include at least reconciliation request (the first reconciliation request 206A). The set of reconciliation requests includes the one or more reconciliation requests. Details about the one or more reconciliation request retrieval operation are provided, for example, in FIG. 2 and FIG. 4A.

At 908, the one or more rules are retrieved from the set of rules to resolve the one or more reconciliation requests. In an embodiment of the disclosure, the computer system 202 retrieves the one or more rules from the set of rules to resolve the one or more reconciliation requests. Details about the one or more rules retrieval operation are provided, for example, in FIG. 2, FIG. 4A, and FIG. 6A.

At 910, the one or more rules are applied to the one or more reconciliation requests. In an embodiment of the disclosure, the computer system 202 applies the one or more rules to the one or more reconciliation requests. Details about the one or more rules application operation are provided, for example, in FIG. 2 and FIG. 4A

At 912, the one or more reconciliation requests are resolved based on the application of the one or more rules. In an embodiment of the disclosure, the computer system 202 resolves the one or more reconciliation requests based on the application of the one or more rules. Details about the reconciliation requests resolution operation are provided, for example, in FIG. 2, FIG. 4A, and FIG. 4B.

At 914, the resolved one or more reconciliation requests are outputted. In an embodiment of the disclosure, the computer system 202 outputs the resolved one or more reconciliation requests. Details about the reconciliation requests output operation are provided, for example, in FIG. 2 and FIG. 4A.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable people of ordinary skill in the art to understand the embodiments disclosed herein.

What is claimed is:

1. A computer-implemented method, comprising:
retrieving, by a computer, one or more reconciliation requests associated with a custom resource from a data structure, wherein:
the data structure comprises a set of reconciliation requests associated with one or more custom resources,
the one or more custom resources comprise the custom resource, and
the set of reconciliation requests comprises the one or more reconciliation requests;
retrieving, by the computer, one or more rules from a set of rules for resolving the one or more reconciliation requests;
applying, by the computer, the one or more rules to the one or more reconciliation requests;
resolving, by the computer, the one or more reconciliation requests based on the application of the one or more rules; and
outputting, by the computer, the resolved one or more reconciliation requests.

2. The computer-implemented method of claim 1, further comprising:
determining, by the computer, a priority order of the retrieved one or more reconciliation requests based on the application of the one or more rules to the retrieved one or more reconciliation requests;
arranging, by the computer, the retrieved one or more reconciliation requests based on the determined priority order; and
resolving, by the computer, the retrieved one or more reconciliation requests based on the arrangement.

3. The computer-implemented method of claim 1, further comprising:
parsing, by the computer, the data structure; and
retrieving, by the computer, the one or more reconciliation requests associated with the custom resource based on the parsing of the data structure.

4. The computer-implemented method of claim 1, further comprising:
intercepting, by the computer, the set of reconciliation requests associated with the one or more custom resources;
determining, by the computer, a set of identifiers associated with the set of reconciliation requests; and
generating, by the computer, the data structure based on the set of identifiers.

5. The computer-implemented method of claim 4, wherein each identifier of the set of identifiers corresponds to at least one of a custom resource creator value, a custom resource namespace, or a custom resource group.

6. The computer-implemented method of claim 1, further comprising:
parsing, by the computer, the retrieved one or more reconciliation requests;
identifying, by the computer, the one or more rules from the set of rules based on the parsing of the retrieved one or more reconciliation requests; and
retrieving, by the computer, the one or more rules from the set of rules based on the identification.

7. The computer-implemented method of claim 1, further comprising:
retrieving, by the computer, a configuration webhook comprising the set of rules; and
retrieving, by the computer, the one or more rules from the set of rules based on the configuration webhook.

8. The computer-implemented method of claim 1, further comprising:
parsing, by the computer, the resolved one or more reconciliation requests and a custom resource definition associated with the custom resource;
determining, by the computer, at least two reconciliation requests of the retrieved one or more reconciliation requests are unresolved upon the application of the one or more rules to the retrieved one or more reconciliation requests based on the parsing of the resolved one or more reconciliation requests and the custom resource definition; and
outputting, by the computer, the at least two reconciliation requests of the retrieved one or more reconciliation requests based on the determination that the at least two reconciliation requests are unresolved.

9. The computer-implemented method of claim 8, further comprising:
receiving, by the computer, a priority order of the at least two reconciliation requests of the retrieved one or more reconciliation requests; and
resolving, by the computer, the at least two reconciliation requests of the retrieved one or more reconciliation requests based on the received priority order.

10. The computer-implemented method of claim 1, further comprising:
controlling, by the computer, reconciliation of the custom resource based on the resolution of the one or more reconciliation requests; and
outputting, by the computer, the reconciled custom resource.

11. The computer-implemented method of claim 10, further comprising:
generating, by the computer, a reconciliation synchronization flag associated with the custom resource;
modifying, by the computer, the reconciliation synchronization flag; and
controlling, by the computer, the reconciliation of the custom resource based on the modified reconciliation synchronization flag.

12. The computer-implemented method of claim 11, further comprising:
retrieving, by the computer, state information associated with the custom resource;
generating, by the computer, a first hash value of the state information associated with the custom resource;
retrieving, by the computer, a second hash value of the state information;
comparing, by the computer, the first hash value with the second hash value; and
controlling, by the computer, the reconciliation of the custom resource based on the comparison.

13. The computer-implemented method of claim 1, further comprising:
retrieving, by the computer, a mutant operand request webhook;
monitoring, by the computer, the resolved one or more reconciliation requests based on the mutant operand request webhook; and
modifying, by the computer, at least one reconciliation request of the resolved one or more reconciliation requests based on the mutant operand request webhook.

14. A computer system, comprising:
a processor set;
one or more computer-readable storage media; and
program instructions stored on the one or more computer-readable storage media, the program instructions executable by the processor set to cause the processor set to:
intercept a reconciliation request associated with a custom resource, wherein the reconciliation request is transmitted from a container operator associated with a container application hosted on a container platform;
arrange the reconciliation request into a data structure based on an identifier associated with the custom resource, wherein the data structure comprises a set of reconciliation requests associated with one or more custom resources, and wherein the one or more custom resources comprise the custom resource;
retrieve one or more reconciliation requests associated with the custom resource from the data structure, wherein the one or more reconciliation requests comprise at least the reconciliation request, and wherein the set of reconciliation requests comprises the one or more reconciliation requests;
retrieve one or more rules from a set of rules to resolve the one or more reconciliation requests;
apply the one or more rules to the one or more reconciliation requests;
resolve the one or more reconciliation requests based on the application of the one or more rules; and
output the resolved one or more reconciliation requests.

15. The computer system of claim 14, wherein the program instructions further cause the processor set to:
determine a priority order of the retrieved one or more reconciliation requests based on the application of the one or more rules to the retrieved one or more reconciliation requests;
arrange the retrieved one or more reconciliation requests based on the priority order; and
resolve the retrieved one or more reconciliation requests based on the arrangement.

16. The computer system of claim 14, wherein the program instructions further cause the processor set to:
intercept the set of reconciliation requests associated with the one or more custom resources;
determine a set of identifiers associated with the set of reconciliation requests; and
generate the data structure based on the set of identifiers.

17. The computer system of claim 14, wherein the program instructions further cause the processor set to:
parse the retrieved one or more reconciliation requests;
identify the one or more rules from the set of rules based on the parsed one or more reconciliation requests; and
retrieve the one or more rules from the set of rules based on the identification.

18. The computer system of claim 14, wherein the program instructions further cause the processor set to:
parse the resolved one or more reconciliation requests and a custom resource definition associated with the custom resource;
determine at least two reconciliation requests of the retrieved one or more reconciliation requests are unresolved upon the application of the one or more rules to the retrieved one or more reconciliation requests based on the parsed one or more reconciliation requests and the custom resource definition; and
output the at least two reconciliation requests of the retrieved one or more reconciliation requests based on the determination that the at least two reconciliation requests are unresolved.

19. The computer system of claim 18, wherein the program instructions further cause the processor set to:
receive a priority order of the at least two reconciliation requests of the retrieved one or more reconciliation requests; and
resolve the at least two reconciliation requests of the retrieved one or more reconciliation requests based on the received priority order.

20. A computer-program product for resolution of one or more reconciliation requests, the computer-program product comprising:
one or more computer-readable storage media; and
program instructions stored on the one or more computer-readable storage media to perform operations comprising:
retrieving the one or more reconciliation requests associated with a custom resource from a data structure, wherein the data structure comprises a set of reconciliation requests associated with one or more custom resources, and wherein the one or more custom resources comprise the custom resource and the set of reconciliation requests comprises the one or more reconciliation requests;
retrieving one or more rules from a set of rules to resolve the one or more reconciliation requests;
applying the one or more rules to the one or more reconciliation requests;
resolving the one or more reconciliation requests based on the application of the one or more rules; and
outputting the resolved one or more reconciliation requests.
